(19) United States
(12) Patent Application Publication
(10) Pub. No.: US 2026/0280846 A1
(43) Pub. Date: Sep. 17, 2026

(54) CONTROLLED EXPOSURE OF ROW-LEVEL SPARSITY PATTERNS FOR EFFICIENT PARTIALLY HOMOMORPHIC EVALUATION OF MACHINE LEARNING WEIGHT MATRICES

(71) Applicants: Constructor Technology AG, Schaffhausen (CH); Constructor Education and Research Genossenschaft, Schaffhausen (CH)

(72) Inventors: Alexander Tormasov, Bremen (DE); Serg Bell, Singapore (SG); Stanislav Protasov, Singapore (SG); Nikolay Dobrovolskiy, Alanya (TR); Laurent Dedenis, Geneve (CH)

(21) Appl. No.: 19/678,371

(22) Filed: May 15, 2026

Related U.S. Application Data
(63) Continuation-in-part of application No. 19/399,724, filed on Nov. 25, 2025.
Application No. 19/399,724 is a continuation-in-part of application No. 19/169,111, filed on Apr. 3, 2025, now Pat. No. 12,500,735.
(60) Provisional application No. 63/575,099, filed on Apr. 5, 2024.

(51) Int. Cl. H04L 9/00

(52) U.S. Cl. CPC H04L 9/008

(57) ABSTRACT

A server receives public row metadata from a client device, detailing sets of non-zero column indices for rows in a weight matrix tied to a linear operation. The server groups these rows into multiple pattern groups, with each group containing rows that share an identical pattern of non-zero column indices. For every pattern group, the server creates a pattern descriptor that specifies the shared pattern. The server then receives an encrypted input vector from the client. Using homomorphic encryption, the server sums the encrypted input vector elements according to each pattern descriptor, producing encrypted partial sums for each group. For every row within a group, the server derives an encrypted row result based on the group's partial sum. Finally, the server sends the encrypted row results, encrypted partial sums, and mapping information that links rows to their corresponding pattern groups back to the client device.

### CROSS-REFERENCE TO RELATED APPLICATIONS

This application is a continuation-in-part application that claims priority to U.S. Non-Provisional application Ser. No. 19/399,724, filed Nov. 25, 2025, which is a continuation-in-part application that claims priority to U.S. Non-Provisional application Ser. No. 19/169,111, filed Apr. 3, 2025, which further claims the benefit of U.S. Provisional Application No. 63/575,099, filed Apr. 5, 2024, all of which are herein incorporated by reference.

### FIELD OF TECHNOLOGY

The present disclosure relates to secure inference for machine learning models executed under encryption, and more particularly to techniques for accelerating evaluation of linear layers in machine learning models using partially homomorphic encryption by selectively exposing row-level sparsity information.

### BACKGROUND

Machine learning models, including large language models, increasingly rely on secure computation techniques to preserve confidentiality of user inputs and model parameters during inference. Partially homomorphic encryption (PHE) schemes that support homomorphic addition allow evaluation of linear operations over encrypted inputs; however, naïve application of PHE to matrix-vector products can incur substantial computational overhead because each row of a weight matrix requires a separate homomorphic accumulation over all positions corresponding to non-zero weights.

In 1-bit or ternary models, weight matrices include elements from the set {−1, 0, +1}, which naturally induce sparsity at the row level, but conventional encrypted evaluation pipelines underutilize this structure when the model's row patterns are kept entirely secret. As a result, systems that strictly conceal all row-level structure miss opportunities for computation sharing and must repeat similar encrypted summations for many rows, leading to unnecessary homomorphic additions and degraded performance.

### SUMMARY

To address the issues previously described, the disclosed techniques speed up encrypted inference for 1-bit or ternary models by revealing just a small, carefully chosen slice of each weight-matrix row's structure (i.e., which positions are non-zero, and their signs) while keeping the rest private to balance security and performance. Using only this public snapshot, a server groups rows that share the same non-zero pattern and creates a compact pattern descriptor for each group. Then, for each group, the server adds up the encrypted input entries at those positions once to form an encrypted “partial sum” that the server can reuse across all rows in the group, rather than repeating the same work for every row.

A client finishes any row-specific steps that depend on private details (like hidden signs or scaling) after decrypting the necessary values, ensuring that inputs and outputs remain confidential. This reuse cuts the number of homomorphic additions compared to per-row computation from scratch, yielding a big efficiency gain in exchange for limited, policy-controlled exposure of sparsity patterns. In practice, one may take a ternary weight matrix, split each row's metadata into public and private according to a policy, send only the public portion, have the server pre-group rows and compute encrypted partial sums under a PHE scheme, and reuse those descriptors and sums across inputs for faster, still-secure inference.

In an exemplary aspect, the techniques described herein relate to a method for securely computing at least a portion of a linear operation of a machine learning model (MLM), the method including: receiving, from at least one client device by at least one server, public row metadata including sets of non-zero column indices for rows of a weight matrix associated with the linear operation; grouping, at the at least one server, the rows of the weight matrix into a plurality of pattern groups based on the public row metadata, wherein each pattern group of the plurality of pattern groups includes two or more rows that share a same pattern of non-zero column indices; generating, for each respective pattern group of the plurality of pattern groups, a pattern descriptor that identifies a pattern of non-zero column indices shared by rows in the respective pattern group; receiving an encrypted input vector from the at least one client device; for each respective pattern group of the plurality of pattern groups: homomorphically summing, using an encryption scheme, encrypted elements of the encrypted input vector selected according to a corresponding pattern descriptor to obtain at least one encrypted partial sum corresponding to the respective pattern group; and deriving, for each row in the respective pattern group, an encrypted row result based on the at least one encrypted partial sum corresponding to the respective pattern group; and transmitting, from the at least one server to the at least one client device, encrypted row results, encrypted partial sums, and mapping information associating rows to pattern groups.

In some aspects, the techniques described herein relate to a method, wherein the at least one client device is configured to: receive, from the at least one server, the encrypted row results, the encrypted partial sums, and the mapping information associating rows to pattern groups; decrypt at least one of the encrypted row results or the encrypted partial sums; and generate, using private row metadata, a plaintext output element of the linear operation for a corresponding row.

In some aspects, the techniques described herein relate to a method, wherein the at least one client device is configured to: determine, for each respective row of the weight matrix, a set of column indices corresponding to non-zero elements to obtain row-level sparsity information; and generate, for each respective row, row metadata that includes the row-level sparsity information.

In some aspects, the techniques described herein relate to a method, wherein elements of the weight matrix include values in {−1, 0, +1}, such that the non-zero elements have magnitude one.

In some aspects, the techniques described herein relate to a method, further including, for each row of the weight matrix, determining a sign for each non-zero element, and wherein the row metadata further includes sign information associated with non-zero positions in the row.

In some aspects, the techniques described herein relate to a method, wherein the at least one client device is configured to: partition, for each respective row, the row metadata into the public row metadata and private row metadata according to a security policy; and transmit the public row metadata to the at least one server in unencrypted form while retaining the private row metadata locally.

In some aspects, the techniques described herein relate to a method, wherein partitioning the row metadata into the public row metadata and the private row metadata includes: designating the row-level sparsity information as part of the public row metadata; and designating at least a portion of sign information associated with non-zero positions in the respective row as part of the private row metadata.

In some aspects, the techniques described herein relate to a method, wherein the security policy designates both the row-level sparsity information and the sign information as the public row metadata, and wherein deriving the encrypted row result includes using the sign information and the encrypted partial sum to compute, using homomorphic operations defined by the encryption scheme, the encrypted row result without using the private row metadata.

In some aspects, the techniques described herein relate to a method, wherein grouping the rows based on the public row metadata includes: computing a pattern key for each row from the public row metadata that encodes at least the pattern of the non-zero column indices; and assigning rows having a same pattern key to a same pattern group.

In some aspects, the techniques described herein relate to a method, wherein homomorphically summing for each pattern group includes applying an addition operation defined by the encryption scheme to ciphertexts associated with encrypted input vector elements at the non-zero column indices indicated by the pattern descriptor for the respective pattern group, while omitting ciphertexts associated with zero elements of the weight matrix.

In some aspects, the techniques described herein relate to a method, wherein the encryption scheme is a partially homomorphic encryption (PHE) scheme.

In some aspects, the techniques described herein relate to a method, wherein the MLM is a 1-bit large language model (LLM), and the weight matrix represents weights of a 1-bit linear layer of the 1-bit LLM.

In some aspects, the techniques described herein relate to a method, further including: performing, at the at least one server, the grouping of rows and the generating of the pattern descriptors as an offline preprocessing operation using the public row metadata; and reusing the pattern descriptors to compute the encrypted partial sums for a plurality of different encrypted input vectors associated with a plurality of invocations of the MLM.

In some aspects, the techniques described herein relate to a method, wherein the at least one client device is configured to: encrypt a plurality of elements of an input vector associated with the linear operation using the encryption scheme to obtain the encrypted input vector; and transmit the encrypted input vector to the at least one server.

In some aspects, the public row metadata is used to route encrypted elements of the encrypted input vector to a shared homomorphic partial-sum computation associated with a pattern group, and the shared homomorphic partial-sum computation is reused for a plurality of rows mapped to the pattern group.

In some aspects, the public row metadata comprises non-zero column indices for each row, and private row metadata retained at the client comprises at least one of: sign information for one or more non-zero entries, row-specific scaling information, or row-specific completion logic, such that the server computes one or more encrypted partial sums using the public row metadata and the client completes a row output using the private row metadata after decryption.

In some aspects, the techniques described herein relate to a method, further comprising storing, at the server, pattern descriptors and row-to-pattern mappings generated from the public row metadata and reusing the stored pattern descriptors and row-to-pattern mappings across a plurality of encrypted input vectors associated with a plurality of invocations of the machine learning model.

It should be noted that the methods described above may be implemented in a system comprising at least one hardware processor and memory. Alternatively, the methods may be implemented using computer executable instructions of a non-transitory computer readable medium.

In some aspects, the techniques described herein relate to a system for securely computing at least a portion of a linear operation of a machine learning model (MLM), the system including: at least one memory; and at least one hardware processor coupled with the at least one memory and configured, individually or in combination, to: receive, from at least one client device by at least one server, public row metadata including sets of non-zero column indices for rows of a weight matrix associated with the linear operation; group, at the at least one server, the rows of the weight matrix into a plurality of pattern groups based on the public row metadata, wherein each pattern group of the plurality of pattern groups includes two or more rows that share a same pattern of non-zero column indices; generate, for each respective pattern group of the plurality of pattern groups, a pattern descriptor that identifies a pattern of non-zero column indices shared by rows in the respective pattern group; receive an encrypted input vector from the at least one client device; for each respective pattern group of the plurality of pattern groups: homomorphically sum, using an encryption scheme, encrypted elements of the encrypted input vector selected according to a corresponding pattern descriptor to obtain at least one encrypted partial sum corresponding to the respective pattern group; and derive, for each row in the respective pattern group, an encrypted row result based on the at least one encrypted partial sum corresponding to the respective pattern group; and transmit, from the at least one server to the at least one client device, encrypted row results, encrypted partial sums, and mapping information associating rows to pattern groups.

In some aspects, the techniques described herein relate to a non-transitory computer readable medium storing thereon computer executable instructions for securely computing at least a portion of a linear operation of a machine learning model (MLM), including instructions for: receiving, from at least one client device by at least one server, public row metadata including sets of non-zero column indices for rows of a weight matrix associated with the linear operation; grouping, at the at least one server, the rows of the weight matrix into a plurality of pattern groups based on the public row metadata, wherein each pattern group of the plurality of pattern groups includes two or more rows that share a same pattern of non-zero column indices; generating, for each respective pattern group of the plurality of pattern groups, a pattern descriptor that identifies a pattern of non-zero column indices shared by rows in the respective pattern group; receiving an encrypted input vector from the at least one client device; for each respective pattern group of the plurality of pattern groups: homomorphically summing, using an encryption scheme, encrypted elements of the encrypted input vector selected according to a corresponding pattern descriptor to obtain at least one encrypted partial sum corresponding to the respective pattern group; and deriving, for each row in the respective pattern group, an encrypted row result based on the at least one encrypted partial sum corresponding to the respective pattern group; and transmitting, from the at least one server to the at least one client device, encrypted row results, encrypted partial sums, and mapping information associating rows to pattern groups.

The above simplified summary of example aspects serves to provide a basic understanding of the present disclosure. This summary is not an extensive overview of all contemplated aspects, and is intended to neither identify key or critical elements of all aspects nor delineate the scope of any or all aspects of the present disclosure. Its sole purpose is to present one or more aspects in a simplified form as a prelude to the more detailed description of the disclosure that follows. To the accomplishment of the foregoing, the one or more aspects of the present disclosure include the features described and exemplarily pointed out in the claims.

### BRIEF DESCRIPTION OF THE DRAWINGS

The accompanying drawings, which are incorporated into and constitute a part of this specification, illustrate one or more example aspects of the present disclosure and, together with the detailed description, serve to explain their principles and implementations.

FIG. 1A is a block diagram of an exemplary secure local LLM deployment in an enterprise.

FIG. 1B is a block diagram of an exemplary secure hosted LLM deployment for an enterprise.

FIG. 2 is a block diagram of exemplary functional modules of the secure LLM deployment for an enterprise.

FIG. 3 illustrates a method for providing a secure LLM deployment in an enterprise.

FIG. 4 illustrates an example of a method for providing a secure LLM deployment in an enterprise using encryption and Access Control List (ACL).

FIG. 5 is a block diagram of an encoder and decoder-based architecture on which encryption is performed.

FIG. 6 is a block diagram of a multi-head attention block.

FIG. 7 is a block diagram of a generalized example for performing LLM operations using a client device and a service provider.

FIG. 8 illustrates another method for securely executing an MLM.

FIG. 9 is a block diagram of a system for secure distributed execution of a MLM using partially homomorphic encryption and ternary weight decomposition.

FIG. 10 is a block diagram of a system for performing secure inference using pattern-based homomorphic evaluation and client-side completion with private row metadata.

FIG. 11 is a flowchart of a method 1100 for securely computing at least a portion of a linear operation of an MLM.

FIG. 12 presents an example of a general purpose computer system on which aspects of a secure LLM deployment in an enterprise can be implemented.

### DETAILED DESCRIPTION

Exemplary aspects are described herein in the context of a system, method, and a computer program for providing a secure large language model (LLM) deployment in an enterprise IT environment. Those of ordinary skill in the art will realize that the following description is illustrative only and is not intended to be in any way limiting. Other aspects will readily suggest themselves to those skilled in the art having the benefit of the disclosure. Reference will now be made in detail to implementations of the example aspects as illustrated in the accompanying drawings. The same reference indicators will be used to the extent possible throughout the drawings and the following description to refer to the same or like items.

In an exemplary aspect, a method for secure distributed processing of data is provided. The method comprises determining whether a first operation of a distributed machine learning model should be executed on at least one server or on at least one client device based on one or more criteria including compatibility with specific encryption schemes, computational load distribution, and associated expense considerations. In response to a determination that the first operation should be executed on the at least one server, the method further comprises encrypting data associated with the first operation using a specific encryption scheme and transmitting the encrypted data to the at least one server for execution of the first operation on the encrypted data. In response to a determination that the first operation should be executed on the at least one client device, the method comprises performing the first operation on the data using the at least one client device without encrypting the data using the specific encryption scheme.

The method enables explicit control over placement of computational load between server-side and client-side resources, allowing selection of execution location to reflect encryption compatibility, throughput requirements, latency constraints, energy consumption preferences, and cost models associated with network transfer and compute usage. Encryption of server-bound data using the specific encryption scheme provides confidentiality during transit and server-side processing, while local execution on the at least one client device without application of the specific encryption scheme reduces overhead when encryption is unnecessary under the selected load distribution and cost profile. The method thereby facilitates secure, configurable, and cost-aware execution of distributed machine learning operations across heterogeneous infrastructure.

The present disclosure describes a secure 1-bit distributed LLM that offers security and computational efficiency. In general, a 1-bit LLM refers to a type of neural network model where the weights and possibly the activations are quantized to 1-bit precision. This means that instead of using the typical 32-bit or 16-bit floating-point numbers to represent the weights and activations, the model uses binary values (0 or 1). This quantization can significantly reduce the memory footprint and computational requirements of the model, making it more efficient in terms of storage and processing.

By using 1-bit precision, the amount of memory required to store the weights of the model is drastically reduced. This can be particularly beneficial for deploying large models on devices with limited memory, such as mobile phones or edge devices. The overall size of the model is also much smaller compared to traditional models with higher precision weights.

Furthermore, operations involving 1-bit values are generally faster and require less power compared to operations involving higher precision values. This can lead to faster inference times and lower energy consumption. The reduced precision can simplify the hardware requirements, allowing for the use of specialized hardware accelerators designed for binary operations.

In particular, 1-bit LLMs are well-suited for deployment on edge devices (e.g., client devices) where memory and computational resources are limited. This facilitates a distribution of the LLM. More specifically, the LLM architecture of the present disclosure is distributed between one or more client devices and one or more servers such that some operations of the LLM are executed on the client device(s) and some on the server(s). To address the security issues of conventional LLMs, data of certain operations of the LLM of the present disclosure are encrypted. In some aspects, the encryption is performed using partial homomorphic encryption (PHE). In some aspects, data of operations executed on the server are encrypted, whereas data of operations executed on the client device are unencrypted. This assures confidentiality of information without wasting resources on encryption where it is not needed (e.g., on a local client device).

In an exemplary aspect, all matrices of weights are represented in 1-bit format. In 1-bit format, there is no multiplication operation (because of data is binarized (−1,0,1) in INT8 format) and only addition operations and change of sign operations are performed. This makes matrix/vector operations on the matrices computationally faster than floating point matrix multiplication. In some aspects, input/output vector data is still represented in floating point format (FP16 format). Because PHE enables addition operations and does not conflict with 1-bit format, PHE may be used for encrypting certain data. The data associated with vector operations and other matrix operations that require multiplication and division is left unencrypted.

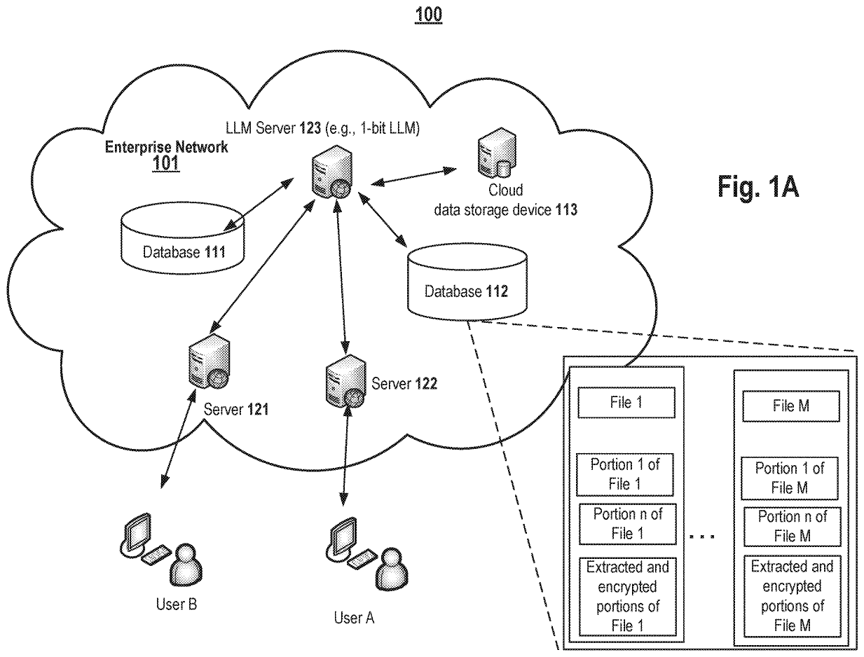

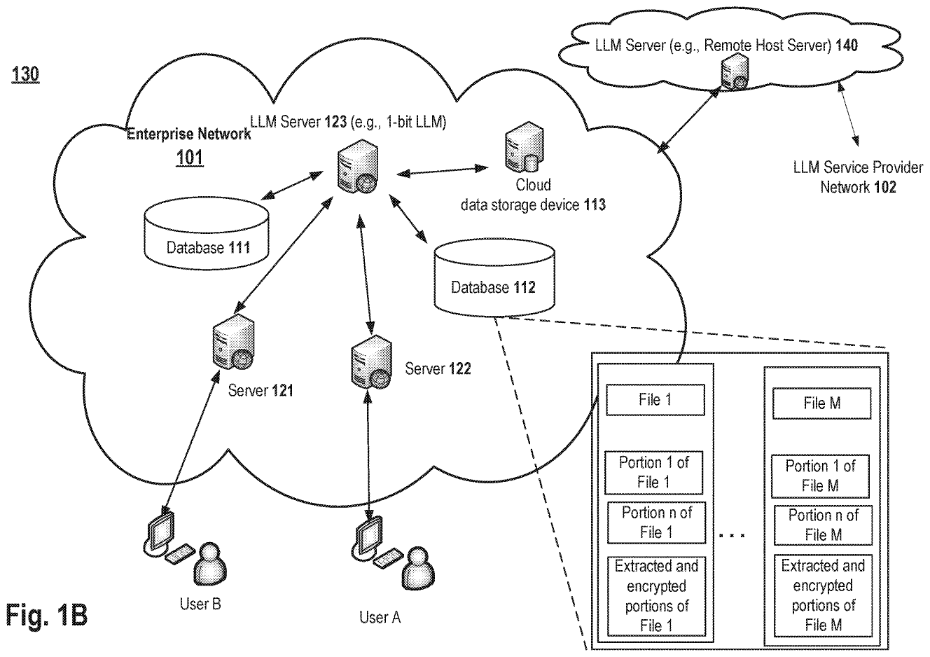

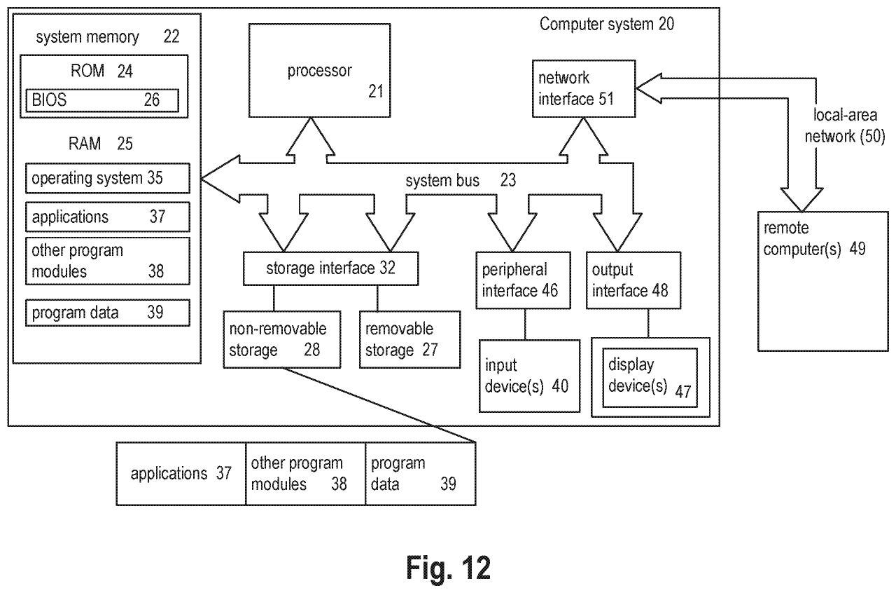

FIG. 1A illustrates a block diagram of an exemplary system 100 for providing a secure local LLM deployment in an enterprise network. In one aspect, the components of system 100 may be implemented on computer systems, such as that shown in FIG. 12.

In one aspect, system 100 includes an enterprise network 101 which includes at least servers 121-123. It is noted that system 100 includes any number of other network components and FIG. 1A only shows the components relevant for the illustrative example of the present disclosure. Users of the enterprise network 101 (e.g., employees or customers) communicate with devices in the enterprise network 101 via one of the servers, e.g., user A communicates with components of the enterprise network 101 via server 122, and user B communicates with components of the enterprise network 101 via server 121. Notably, certain operations of the 1-bit LLM of the present embodiment are implemented on LLM server 123.

In addition, enterprise network 101 includes any number of database servers, such as the database servers 111 and 112. In one aspect, data of the enterprise network may also be stored on a cloud storage device, such as the storage device 113 (also referred to as database server 113). Thus, files of the enterprise network may be stored in any of the database servers 111-113. For example, files 1-M, are shown as being stored on the database server 112. In one aspect, the files 1-M may contain any number of portions of data, with some portions being confidential data. Thus, at least some of the portions of the files 1-M may also be encrypted and stored on any of the database servers 111-113.

FIG. 1B illustrates a block diagram of an exemplary system 130 for providing a secure hosted LLM deployment on a remote server 140 for an enterprise. Thus, the system 130 is for the scenario in which the enterprise network accesses LLM functionality from a service provider (e.g., cloud service provider) rather than deploying the functionality on a server of the enterprise.

In one aspect, the system 130 includes an enterprise network 101 which includes at least servers 121-123. The enterprise network 101 is communicatively coupled to an LLM service provider network 102 for accessing LLM functionalities. That is, rather than deploying all of the LLM functionality on the enterprise network 101, the enterprise subscribes to the LLM functionality from a service provider. Users of the enterprise network 101 communicate with devices in the enterprise network 101 via one of the servers, e.g., user A communicates with components of the enterprise network 101 via server 122, and user B communicates with components of the enterprise network 101 via server 121. The LLM of service provider is implemented on the server 140 located in the LLM service provider's network 102.

To enable enterprise employees to use LLM services to intelligently search and query data files and documents stored in the enterprise database, in one exemplary aspect, the LLM server 140 may be configured to operate on the encrypted confidential data of the enterprise network 101. Particularly, in one aspect, the LLM server 140 may be configured to perform LLM training, LLM fine-tuning, and LLM inference (and any other required operations) using the encrypted data without being able to decrypt it, which provides a high-degree of security to the enterprise data. Thus, the 1-bit LLM functionality installed on LLM server 140 has no access to encrypted versions of the confidential data. Moreover, in another example aspect, the user prompts may also be encrypted to allow an even greater degree of confidentiality.

In another aspect where the LLM service provider is a trusted service provider and can have access to unencrypted data, the LLM server 140 accesses data stored in the database servers 111-113, and performs all LLM operations including the encrypting of the content stored on the database servers 111-113. In this scenario, the training, retraining, and fine-tuning of the LLM may be performed by the trusted service provider.

In one of the scenarios, a Large Language Model (LLM) is deployed on the service side in encrypted mode. The user wants to interact with the LLM while keeping the query and answer encrypted. In this case, the query is encrypted using Partially Homomorphic Encryption (PHE) and sent to the service side. The LLM processes this query using addition operations in PHE mode, generates results from these operations, and sends the results back to the user. The user then decrypts the results from the service, performs complex operations on their side, encrypts their results, and sends them again to the service. This back-and-forth exchange allows the service side to manage the bulk of the addition operations, which are the most frequent and thus computationally consuming. Ultimately, the user obtains the final result, while most of the computational load remains on the service side. However, the service does not have access to the query, response, or intermediate results, as they are encrypted and processed in PHE mode. Consequently, the service remains unaware of the details of the query and response.

In one embodiment between the service and user, there is a gateway that can transform PHE to standard encryption, allowing the user to decipher using light standard encryption. There is also a gateway that can work in the opposite direction.

For an illustrative non-limiting example, suppose the enterprise network comprises a hospital network with users having access to different portions of data stored in various databases of the hospital. In one aspect, the hospital may obtain LLM services from a trusted service provider. The trusted service provider may then access the data, encrypt the data as needed, set up access lists (if applicable) for various groups of users (e.g., doctors, nurses, administrators, IT personal, etc.), provide decryption keys to users allowed to access certain portions of data, etc. For example, portions of the medical records containing patients' names may be encrypted, but the information about patient's medical condition, treatment protocols and the results of the treatment may remain unencrypted. The LLM may be trained on these partially encrypted filed. When a query is received from a user for an LLM service (e.g., search for information about successful treatment of a particular medical condition), after authenticating the user and checking his access level, the inference module of the LLM server may generate a response to the user prompt. For example, the LLM, which was trained on the patient records, may identify successful treatment cases and summarize conditions of patients and their treatment protocols without revealing patients' names if users access level prohibits access to this information.

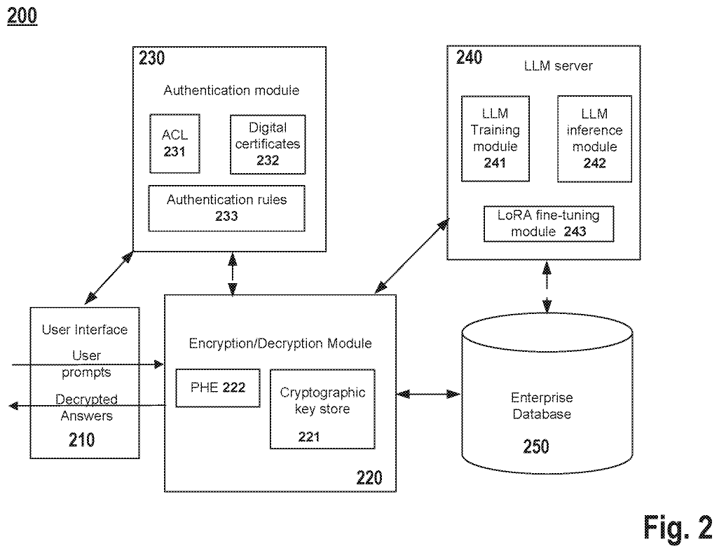

FIG. 2 is an example of a block diagram of functional modules of the system 200 for secure LLM deployment for an enterprise according to one exemplary aspect. Some of these functional modules may be deployed locally on the servers of the enterprise network 101 or hosted on a remote server such as server 140. In one example aspect, the system 200 includes the following functional modules: a user interface 210, an encryption/decryption module 220, an authentication module 230, an LLM server 240, and enterprise databases 250.

In one aspect, the user interface 210 is designed to enable user endpoint devices to access enterprise's LLM functionality in a secure and confidential manner. User interface 210 may be implemented as web-based interface or a desktop application. The user interface 210 allows users to use text prompts to perform text-based searches for documents in enterprise database 250, to query the LLM server 240 for answers to specific questions related to the documents and files stored in the enterprise database 250, or, depending on the natural language processing capabilities of the LLM server 240, to simulate a conversation with the LLM server 240 on topics related to the documents contained in the database 250 or other topics on which the LLM server 240 has been trained to answer. In one aspect, the access to the LLM services and/or to confidential documents in the enterprise database 250 is allowed to authenticated users only and/or users who have an appropriate level of access (e.g., doctors, administrators, IT staff, etc.).

In one aspect, the authentication module 230 is provided to enable authentication of users that access LLM services of the enterprise via the interface 210. In one example, the authentication may be performed using an Access Control List (ACL) 231, identifying individual users and their respective access level to documents in the enterprise database. In another example, the authentication can be performed using cryptographic techniques, such as digital certificates 232 associate with individual users. Yet in another example, various authentication rules 233 may be used to specify the access level of individual users or groups/categories of users, what confidential data is accessible to the users, whether user's LLM prompts should be encrypted, etc. Alternatively, a combination of these and other known authentication techniques may be used.

For example, if a user query does not include the key(s) associated with an authorized user (as indicated in ACL 231), basic unencrypted LLM data and matrices are used. If the keys are provided, depending on the level of access, whole matrices and LLM data with both encrypted and encrypted data may be used. In some aspects, different LLMs are trained, each with a different amount of access to data. For example, a limited LLM may be able to provide simple answers without confidential data. A full LLM may provide more advanced answers for users having access keys.

In order to access LLM services external to the enterprise while maintaining the security of user prompts and confidential enterprise data, the enterprise may encrypt its confidential data using homomorphic encryption that allows LLM server 240 to perform operations on the encrypted data without decryption thereof. In one example, the encryption/decryption module 220 is deployed on a server in the enterprise network 101 and configured to perform encryption/decryption of confidential data using PHE 222. An advantage of using PHE is that it is more efficient than FHE in terms of computational load, particularly for 1-Bit LLM implementations.

Furthermore, since homomorphic encryption used by the module 220 is a form of asymmetric encryption algorithm that uses private/public key pairs for encryption and decryption of data files, module 220 may store all generated cryptographic key pairs in a datastore 221. Furthermore, since module 220 may be also configured to encrypt user prompts, which provides an extra level of security and confidentiality to the enterprise, the cryptographic keys generated for each user to encrypt his/her prompts are also stored in the datastore 221.

PHE is a cryptographic technique that enables specific types of computations on encrypted data while maintaining its confidentiality. Unlike FHE, which allows arbitrary computations on encrypted data, PHE supports only certain operations (e.g., addition, multiplication—but not both simultaneously). Accordingly, when matrix operations involving addition or multiplication are performed by an LLM to generate outputs, the operations remain successful and generate proper results despite the encryption. In another example, suppose that the LLM is trained on a document that states “Mary was born on Jan. 1, 1990.” If the birthdate is encrypted (suppose that the encrypted value generated using an encryption key is 123432), the modified document may state “Mary was born on 123432.” The LLM may be trained using this modified document, which prevents the actual birthdate from being leaked/stolen. The trained LLM may generate an output stating “Mary's birthdate is 123432” to a user query “what is Mary's birthdate?”. Here, the output includes the encrypted value of the birthdate. A user with a decryption key may be able to generate the statement “Mary's birthdate is Jan. 1, 1990” using this key.

In some aspects, the PHE used in the present disclosure may be the Paillier cryptosystem, which supports addition operations on encrypted values. This means that one can perform additions on ciphertexts without decrypting them first. PHE is valuable in scenarios where specific computations need to be performed on sensitive data while it remains encrypted, such as in privacy-preserving computations in the cloud or secure multi-party computations. By allowing limited operations on encrypted data, PHE strikes a balance between data utility and confidentiality, enabling practical applications of secure computation in various domains, including finance, healthcare, and decentralized systems. In some aspects, PHE schemes can be performed with a pair of keys based on, for example, RSA (a public-key cryptosystem). In other aspects, PHE schemes can be performed with a single key based on, for example, the Paillier cryptosystem.

In one example aspect, the system 200 further comprises an LLM server 240 that executes an LLM program. The LLM server 240 may be deployed on a local enterprise server, as shown in FIG. 1A, or on a remote host server, as shown in FIG. 1B. The LLM server 240 includes a LLM training module 242, LLM inference module 242, and LLM fine-tuning module 243. The training module 241 is configured to train LLM on files stored in enterprise database. In one aspect, an LLM may be trained both on the unencrypted files that do not contain any confidential data and encrypted files that contain confidential data. In another aspect, LLM may be pretrained using unencrypted files, and then finetuned by module 243 using encrypted files. Notably, PHE encryption allows LLM training, finetuning, and inference to be performed on the encrypted files. Particularly, matrix-vector mathematical operations can be performed on the encrypted data. This allows enterprise to use LLM services while maintaining the secrecy of the confidential data.

In one aspect, fine-tuning module 243 may implement Low-Rank Adaptation (LoRA) algorithm, which provides high-efficiency LLM optimization. For example, prompts and corresponding responses (e.g., samples from historical data) may be used for fine-tuning the LLM for a specific task. The fine-tuning using the LoRA technique involves differentiating new elements that are not well represented in previous training sets of data and modified elements that are recognized, but not adequately represented in previous training sets of data, and then modifying a small portion of weights of the model for performing the fine-tuning. Thus, the weights of the model affected by the new elements and modified elements are changed to improve the accuracy of the LLM training. In one aspect, the LoRA fine-tuning module 243 of the present disclosure is used to further optimize the performance on the PHE encrypted data. LoRA-related data may be stored separately and be encrypted, e.g., by the PHE algorithm, in the same way as described above.

In terms of training, the LLM may be trained through a process called unsupervised learning on a large dataset comprised of text from across various sources (e.g., webpages, documents, articles, etc.). The training begins by initializing the model with random parameters. The LLM then processes sequences of text, ranging from a few words to entire paragraphs, predicting the next word in each sequence. These predictions are compared to the actual next words in the dataset, and the model adjusts its parameters to minimize the difference between its predictions and the actual text. This process, known as backpropagation, is repeated iteratively over several (millions or possibly billions) text examples, allowing the model to learn intricate patterns, grammar rules, contextual understanding, and semantic relationships. The model's objective during training is to maximize the likelihood of generating the correct next word given a sequence of previous words. Additionally, fine-tuning techniques may be applied to adapt the model to specific tasks or domains, further enhancing its performance and applicability. Through this iterative process, the LLM gradually develops a nuanced understanding of language and can generate coherent and contextually appropriate responses to a wide range of queries.

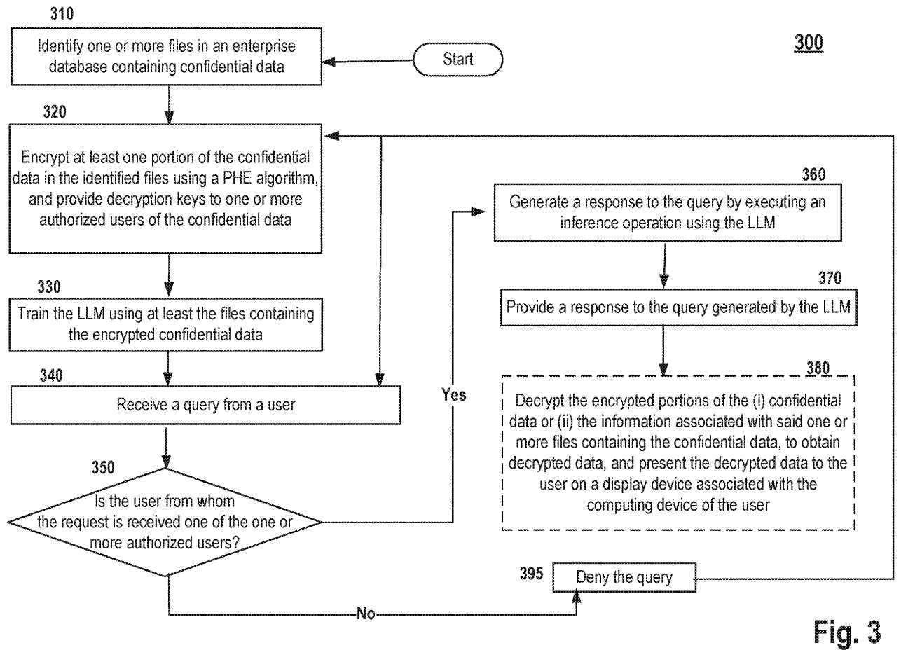

FIG. 3 illustrates a method 300 for providing a secure LLM deployment in an enterprise in accordance with aspects of the present disclosure. In step 310, method 300 identifies one or more files in an enterprise database containing confidential data. The enterprise database is configured to limit access to the confidential data based on an encryption of the confidential data.

In one aspect, the limit to the access to the confidential data is further based on a user's access level. For example, user A may have a different access level from user B. Moreover, based on their respective roles in the enterprise, users A and B may have different needs for accessing different portions of the confidential data. For instance, if the enterprise is a hospital, doctors, nurses, patients, hospital administrators, IT personal etc., would have differing needs for accessing confidential data. Thus, an access control list (ACL) may be used to facilitate compliance to established policies and regulations. The ACL may be implemented on any of the servers of the enterprise. Gateway devices communicating with users may then access the ACL to determine whether access to confidential data is to be granted to a particular user. As mentioned above, a user may be granted access to specific portions of confidential data.

Thus, in one aspect, the determination of whether the user from whom the request is received is one of the one or more authorized users is further based on an ACL of the enterprise.

In step 320, by a server, method 300 encrypts at least one portion of the confidential data in the identified files using a partial homomorphic encryption (PHE) algorithm, and provides decryption keys to one or more authorized users of the confidential data.

In one aspect, the encrypting of the at least one portion of the confidential data further includes: identifying a plurality of matrix-vector operations, performed during the training of the LLM, that are associated with the confidential data; and encrypting the plurality of identified matrix-vector operations using the PHE algorithm, wherein encrypting further includes: encrypting the confidential data stored in the matrix, and encrypting logical operations performed on vector-matrix.

In step 330, by the server, method 300 trains the LLM using at least the files containing the encrypted confidential data. Once the training of the LLM is completed, the LLM server is ready to respond to prompts by performing an inference operation.

In one aspect, the LLM is a 1-bit LLM where an operation of multiplication of matrix to vector is efficiently replaced by changes of sign and addition.

In one aspect, the training of the LLM comprises: taking a LLM partially trained at least on files from enterprise database that do not contain any confidential data; and completing the training using the files containing the encrypted confidential data.

In step 340, by the server, method 300 receives a query from a user, wherein the query comprises a request (i) for searching for the one or more files containing the confidential data or (ii) for obtaining information associated with said one or more files.

In step 350, by the server, method 300 determines whether the user from whom the request is received is one of the one or more authorized users of (i) the one or more files containing the confidential data or (ii) the information associated with said one or more files containing the confidential data. When the user from whom the request is received is one of the one or more authorized users, the method proceeds to step 360. When the user from whom the request is received is not one of the authorized users, the method proceeds to step 395.

In one aspect, the determination of whether the user from whom the request is received is one of the one or more authorized users, includes: identifying one or more files associated with the query received from the user; for each identified file associated with the query received from the user which is among the one or more files containing the confidential data, applying the ACL of the enterprise; and generating the response by executing the inference operation only on the one or more files for which the user's access level is determined as being sufficient.

In step 360, by the server, method 300 generates a response to the query by executing an inference operation using the LLM. For example, the server may prompt an LLM server for a response to the query.

In one aspect, the LLM operation may be implemented on the same server as the server interacting with the user. In another aspect, the server interacting with the user is distinct from the server performing the LLM operations.

In one aspect, the LLM is deployed on a server located in the network of the enterprise. In another aspect, the LLM is deployed on a remote server, which may be a cloud server or a server of a service provider providing LLM functionality to the enterprise.

In step 370, by the server, method 300 provides a response to the query generated by the LLM, wherein, when the response includes the at least one portion of the confidential data that is encrypted, the encrypted portion of the confidential data is decryptable using the decryption key provided to the user of the one or more authorized users.

In one aspect, the generating of the response to the query by executing the inference operation using the LLM comprises: prompting the LLM using encrypted prompts, thereby an LLM hosting platform that performs the inference operation replies to the prompt without decrypting the encrypted at least one portion of confidential data. For example, the prompt from the user is processed by the user interface 210 to generate a vector of features of the prompt. Then, the PHE 222 is used to encrypt the vector and send the resulting encrypted prompt to the LLM server 240. The LLM server 240 operates on the encrypted prompt to generate a response via the LLM inference module 242, and sends the generated response. Then, the response is decrypted by encryption/decryption module 220 and sent to the user interface 210.

In one aspect, the response to the query from the user includes at least encrypted portions of (i) confidential data or (ii) information associated with said one or more files containing the confidential data.

In one aspect, once the computing device of the user receives the response from the server, the computing device of the user decrypts the encrypted portions of the (i) confidential data or (ii) the information associated with said one or more files containing the confidential data, to obtain decrypted data. Then, the computing device of the user presents the decrypted data to the user on a display device associated with the computing device of the user.

Thus, in optional step 380, by the computing device of the user, method 300 decrypts the encrypted portions of the (i) confidential data or (ii) the information associated with said one or more files containing the confidential data, to obtain decrypted data; and presents the decrypted data to the user on a display device associated with the computing device of the user. The method then proceeds to step 320 and/or 340 to continue encrypting newly received confidential data and/or receive queries from users.

In step 395, by the server, method 300 provides a response to the query denying the request. The method then proceeds to step 320 and/or 340 to continue encrypting newly received confidential data and/or receive queries from users.

In one aspect, operations of the enterprise other than the operations provided using the secure LLM are performed on unencrypted data.

In one aspect, operations of the enterprise other than the operations provided using the secure LLM are performed on data encrypted using a Fully Homomorphic Encryption (FHE) algorithm.

In one aspect, the method further comprises: executing steps without decrypting the at least one portion of the confidential data that is encrypted, at least for one of: inference operations, training of algorithms, retraining of algorithms, data preparation and specialization of the algorithm for a specific application.

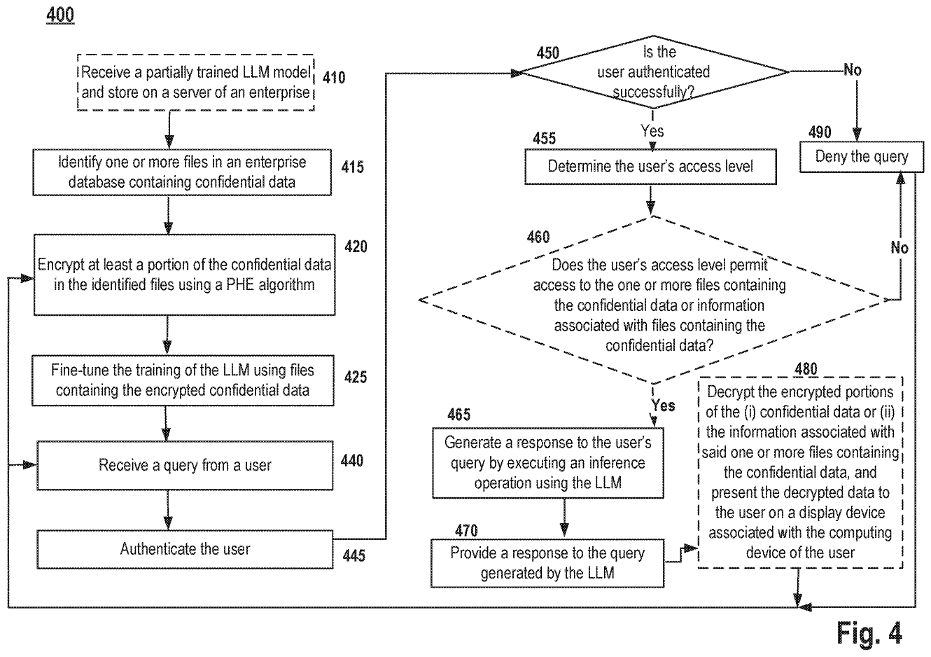

As described above, during execution of the steps of method 300, the enterprise database is configured to limit access to the confidential data based on an encryption of the confidential data. However, the ACL was an optional feature. The usage of the ACL when it is not optional is further described below in conjunction with FIG. 4. Method 300 mainly uses encryption techniques for data security by providing the decrypting keys only to authorized users. Thus, users of the enterprise network may be provided different decryption keys for accessing different portions of confidential data. Alternatively, a method for providing the secure LLM may use both the encryption and the ACL in an integrated manner.

FIG. 4 illustrates an example of a method 400 for providing a secure LLM deployment in an enterprise using encryption and Access Control List (ACL) in accordance with aspects of the present disclosure.

In optional step 410, method 400 receives a partially trained LLM algorithm and stores the partially trained LLM on a server, e.g., a server of the enterprise.

In step 415, method 400 identifies one or more files in an enterprise database containing confidential data. The enterprise database is configured to limit access to the confidential data based on an encryption of the confidential data and usage of ACL.

In step 420, by a server, method 400 encrypts at least one portion of the confidential data in the identified files using a PHE algorithm, and provides decryption keys to one or more authorized users of the confidential data.

In step 425, by a server, method 400 fine-tunes the trained LLM using files containing the encrypted confidential data.

In step 440, by the server, method 400 receives a query from a user, wherein the query comprises a request (i) for searching for the one or more files containing the confidential data or (ii) for obtaining information associated with said one or more files.

In step 445, by the server, method 400 authenticates the user.

In step 450, by the server, method 400 determines whether the user is authenticated successfully. When the user is authenticated successfully, method 400 proceeds to step 455. Otherwise, the method proceeds to step 490.

In step 455, by the server, method 400 determines the access level of the user from whom the query is received.

In step 460, by the server, method 400 determines whether the access level of the user permits access to the one or more files containing the confidential data or (ii) the information associated with said one or more files containing the confidential data. When the access level of the user permits access to the confidential data or (ii) information associated with said one or more files, method 400 proceeds to step 465. When the access level of the user does not permit access to the confidential data or (ii) for obtaining information associated with said one or more files, method 400 proceeds to step 490.

In step 465, by the server, method 400 generates a response to the query by executing an inference operation using the LLM.

In step 470, by the server, method 400 provides a response to the query generated by the LLM, wherein, when the response includes the at least one portion of the confidential data that is encrypted, the encrypted portion of the confidential data is decryptable using the decryption key provided to the user of the one or more authorized users.

In optional step 480, by the computing device of the user, method 400 decrypts the encrypted portions of the (i) confidential data or (ii) the information associated with said one or more files containing the confidential data, to obtain decrypted data; and presents the decrypted data to the user on a display device associated with the computing device of the user.

In step 490, method 400 denies the query. The method may then proceed to step 440 to receive more queries, or to step 420 to receive more data for encryption.

In one aspect, the LLM is a 1-bit LLM where an operation of multiplication of matrix to vector is efficiently replaced by changes of sign and addition.

In one aspect, the LLM is deployed on a local enterprise server.

In one aspect, the LLM is deployed on a remote host server.

In one aspect, encrypting at least the confidential data further includes: identifying a plurality of matrix-vector operations, performed during the training of the LLM, that are associated with the confidential data; and encrypting the plurality of identified matrix-vector operations using the PHE algorithm, wherein encrypting further includes: encrypting the confidential data stored in the matrix, and encrypting logical operations performed on vector-matrix.

In one aspect, the response to the user's query includes at least encrypted portions of (i) confidential data or (ii) information associated with said one or more files containing the confidential data.

In one aspect, the determination of whether the user's access level permits access to (i) the one or more files containing the confidential data or (ii) the information associated with said one or more files containing the confidential data, includes: identifying one or more files associated with the user's query; for each identified file associated with the user's query which is among the one or more files containing the confidential data, applying the ACL of the enterprise; and generating the response to the user's query by executing the inference operation only on the one or more files for which the user's access level is determined as being sufficient.

In one aspect, operations of the enterprise other than the operations provided using the secure LLM are performed on unencrypted data.

In one aspect, operations of the enterprise other than the operations provided using the secure LLM are performed on data encrypted using a Fully Homomorphic Encryption (FHE) algorithm.

In one aspect, the method further comprises executing steps without decrypting the at least one portion of the confidential data that is encrypted, at least for one of: inference operations, training of algorithms, retraining of algorithms, data preparation and specialization of the algorithm for a specific application.

In one aspect, the generating of the response to the query by executing the inference operation using the LLM comprises: prompting the LLM using encrypted prompts, thereby an LLM hosting platform that performs the inference operation replies to the prompt without decrypting the encrypted at least one portion of confidential data.

Integrating PHE into training a LLM involves encrypting the sensitive data involved in the training process, such as the training data itself, gradients, or model parameters.

In one aspects, training data is encrypted using PHE before being sent to the training server. This ensures that the data remains confidential throughout the training process. Techniques like additive or multiplicative homomorphic encryption can be used based on the specific operations required during training.

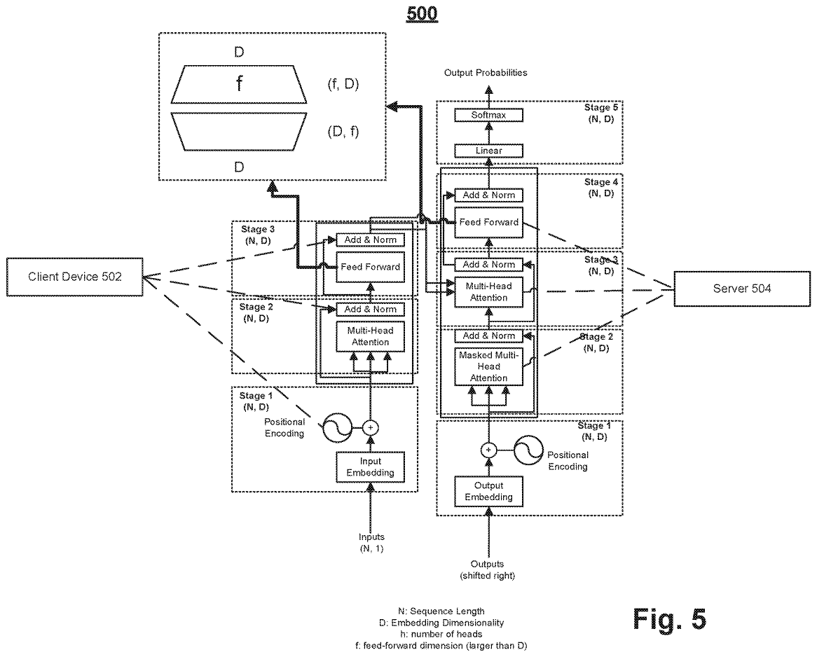

FIG. 5 is a block diagram of an encoder and decoder-based architecture 500 on which layer-specific encryption is performed. Architecture 500 significantly reduces memory footprint and energy consumption and can be effectively scaled to even larger language models with potential benefits in terms of performance and efficiency. Here, D represents embedding dimensionality and is a small vector, h is a number of heads and is also a small number, and f is a feed-forward dimension, which is a large matrix (implement feed-forward using 1-bit format). The system performs training on encrypted data and to generate 1-bit encrypted matrices.

An encoder is used to analyze user queries and a decoder is used to generate answers to the queries. The encoder may be stacked Nx layers high (multiple encoder layers) and likewise the decoder may be stacked Nx layers high. These layers are distributed over client device 502 (e.g., server 121) and server 504 (e.g., LLM server 140).

In architecture 500, all large weight matrices are in 1-bit format and therefore operations with those matrixes (e.g., linear, feed forward, matmul operations) are encrypted using PHE, and sent from client device 502 in secrecy for training or inference to server 504 hosting other layers of the architecture 500. In some aspects, vectors including embeddings or training data may be encrypted using PHE. Furthermore, operations on matrixes and vectors may be encrypted in PHE.

Architecture 500 is marked showing dimensionality of each stage. A typical transformer architecture includes stacks of attention and feed forward layers. In some aspects, there may be 12 layers.

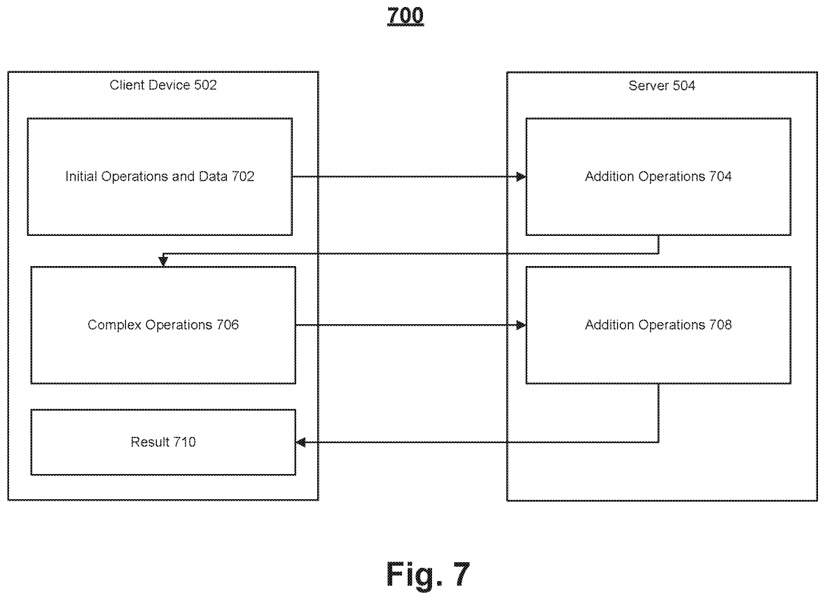

Linear, feed forward, matmul operations involve matrix-vector multiplication and addition and can be performed in 1-bit format. All other operations, which involve not only multiplication/additions, but other operations, such as normalization operation (e.g., Layernorm) which transforms all numbers in vectors to 0-1 range and involves division operation, and Scaled Dot-Product Attention (shown in FIG. 7), which also involves division and square root operation, cannot be performed in 1-bit format and cannot be PHE encoded. These, operations can be encrypted using other techniques or performed on the client device 502.

For example, in the architecture 500, the positional encoding block involves sin and cosine functions and division and therefore cannot be PHE encoded. Such encoding may be performed on the client device 502.

In another example, the vector input into a feed forward block at stage 3 may be PHE-encrypted by client device 502 and sent to server 504. All weight matrixes stored on the server 504 involving a feed forward operation may be in 1-bit format and PHE encrypted. The server 504 will perform the feed forward operation on the PHE-encrypted vector and PHE-encrypted matrixes, and return a PHE-encrypted result to the client device 502. The client device 502 will decrypt the received data and perform the Add&Norm operation of Stage 3. Then, the client device 502 may encrypt results using PHE and send it back to the server 504 to perform Multi-Head Attention at stage 3 (right-hand column of architecture 500). Masked Multi-Head attention is also performed using 1-bit architecture (where all weights are in 1-bit format).

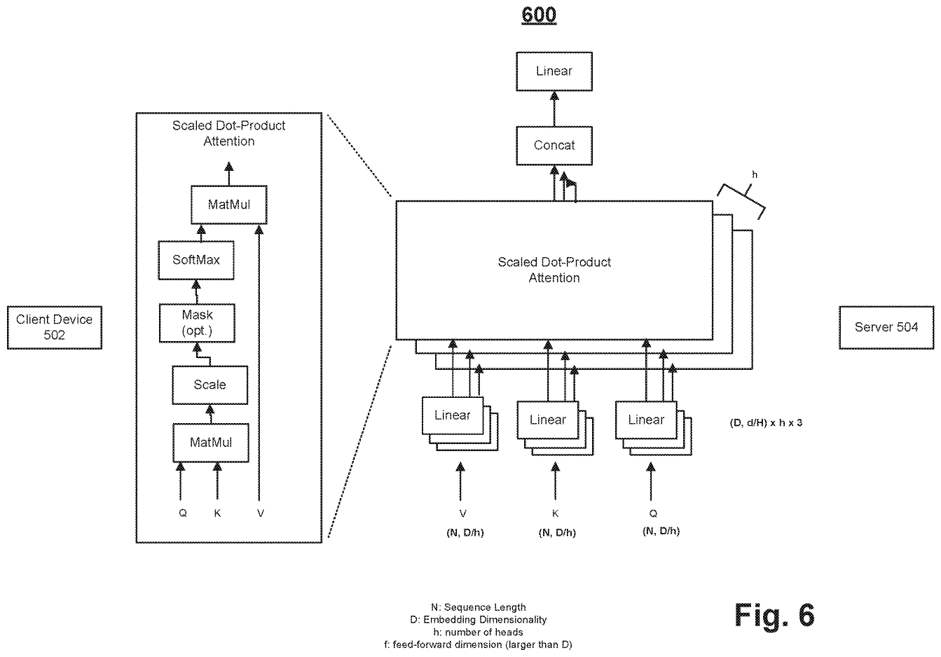

FIG. 6 is a block diagram of a multi-head attention block 600. In some aspects, Multi-Head Attention, which involves a linear operation followed by Scaled Dot-Product Attention, may also be split between the client device 502 and server 504. Linear operations can be performed on PHE encrypted 1-bit matrices, and Scaled Dot-Product Attention, which involves division and square root operation, can be performed on the client device 502 or in FHE encrypted from on the server 504. In fact, the Attention operation has low dimensionality and therefore is not computationally intensive and can be easily performed by the client device 502 in unencrypted form.

The scale block involves division and a square root function and is therefore not compatible with PHE. Softmax involves exponents and division. The Mask block is simply matrix addition and can be 1-bit and PHE encrypted performed on the server. MatMul is matrix multiplication, which can be in 1-bit format, PHE encoded and performed on the server 504.

Compared with regular transformers or other 1-bit LLMs such as BitNet, architecture 500 keeps components high-precision, e.g., 8-bit. In other words, in the BitNet system, 1-bit transformers are trained from scratch (not converted). However, in the present disclosure input and output vectors are still in floating point format (FP16). This is for multiple reasons. First, the residual connections and the layer normalization contribute negligible computation costs to LLMs. Second, the computational cost of QKV transformation is much smaller than the parametric projection as the model grows larger. Third, the precision is preserved for the input/output embedding because the language models have to use high-precision probabilities to perform sampling.

In some aspects, only linear layers are quantized (i.e., in 1-bit format). The quantization is performed per tensor during training while per token during inference for both stability and efficiency.

FIG. 7 is a block diagram 700 of a generalized example for performing LLM operations using a client device and a service provider. In diagram 700, initial operations and data 702, addition operations 704, complex operations 706, and addition operations 708 are all part of an LLM. For example, the operations may be performed in different layers of the LLM.

Initial operations and data 702 are performed on client device 502. Because addition operations 704 is compatible with PHE, client device 502 may encrypt the input of operations 704 using PHE and transmit them to server 504. The results of operations 704 are returned to client device 502, which may then decrypt the result and perform complex operations 706 that are incompatible with PHE. Because addition operations 708 are compatible with PHE, the results of operations 706 may be encrypted using PHE and transmitted to server 504. Server 504 ultimately transmits result 710 to client device 502, which decrypts the result for presentation to a user.

In some aspects, the first operation comprises computing a square root of a number via series expansion using addition and multiplication operations. In general-case square root calculation for scaled dot-product attention in low-precision transformer inference, a series-based realization can be employed without reliance on full-precision computation throughout the pipeline. A method is provided to apply a scaling factor s=1/√(d_k) while retaining binarized weight and activation paths for the heavy tensor operations. The method comprises precomputing the per-head scale s outside the 1-bit path using multi-bit accumulators, with d_k known and constant per head, by computing s once during initialization or offline via a low-degree polynomial approximation evaluated using Horner's method, a lookup from precomputed values, or a power-of-two approximation with m such that s≈2^{m}; the selected s is stored per head as a small higher-precision constant (e.g., FP16 or fixed-point int16). During attention computation, binary projections are performed such that Q=sign(X W_Q), K=sign(X W_K), and V=sign(X W_V), producing 1-bit activations and enabling binary multiplications in the projection path. Query-key dot products are computed using an XNOR plus popcount kernel (alternatively sign multiplication plus sum), with the resultant popcount or sum accumulated in a multi-bit accumulator (e.g., int16 or int32). The stored scale s is then applied to the multi-bit dot-product accumulator by multiplication in higher precision or, where s is a power of two approximation, by bit-shift on the accumulator. Softmax is executed in higher precision, with FP16 or INT32 logits and exponentiation/summation, and value mixing optionally maintained in low or mixed precision while using accumulators for weighted sums. The method confines non-1-bit arithmetic to precomputation of s, per-logit scaling, and softmax reductions, while preserving 1-bit efficiency for weight and activation storage, binary matrix multiplications in Q/K/V projections, and the XNOR/popcount inner-product kernels. By decoupling square root computation from inference via series expansion or lookup evaluated once per head and by applying the resulting constant scale within the accumulator path, the approach eliminates runtime square root evaluation, maintains binarized throughput for core tensor operations, and achieves accurate scaling of attention logits with minimal precision overhead.

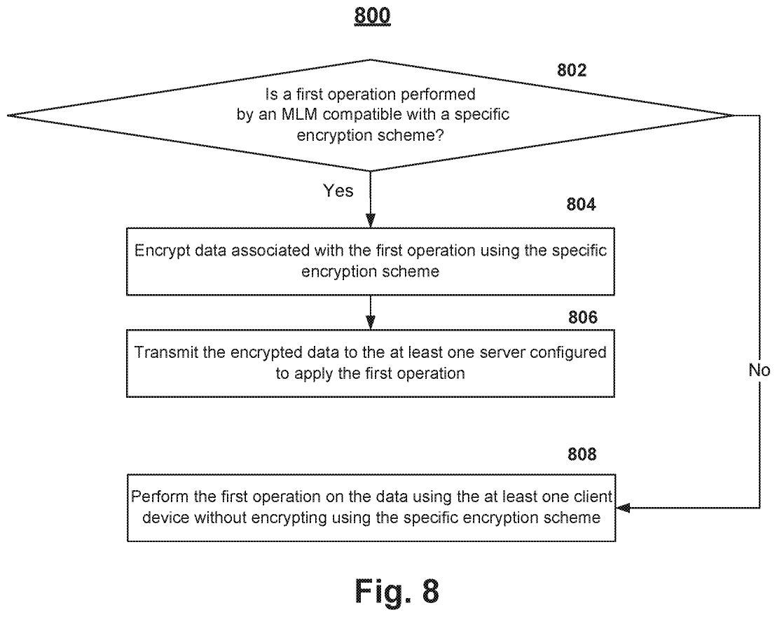

FIG. 8 illustrates method 800 for securely executing an MLM. At 802, module 220 determines whether a first operation performed by an MLM is compatible with a specific encryption scheme. In some aspects, the specific encryption scheme is PHE and the MLM is a 1-bit LLM. It should be noted that in method 800, the MLM is distributed over at least one client device (e.g., client device 502 that is in enterprise network 101) and at least one server (e.g., server 504 that is part of LLM service provider network 102).

Determining the compatibility of a first operation with PHE involves assessing whether the operation can be simplified or transformed into addition operations. This is because PHE schemes typically support a limited set of operations, such as addition, on encrypted data without requiring decryption. For instance, consider matrix multiplication, a common operation in data processing. Matrix multiplication involves a series of multiplications and additions. However, it can be decomposed into a series of addition operations by breaking down the multiplication into repeated addition, which aligns with the capabilities of PHE. Similarly, if the first operation is a linear operation, such as a linear transformation or a linear combination of variables, module 220 can convert this operation into a series of addition operations.

Accordingly, in some aspects, determining whether the first operation is compatible with the specific encryption scheme involves determining whether the first operation can be reduced to one or more addition operations (which are compatible with PHE). Suppose the first operation comprises a linear operation; module 220 may convert the linear operation into one or more addition operations.

In response to determining that the first operation is compatible with the specific encryption scheme, method 800 advances to 804, where module 220 encrypts data associated with the first operation using the specific encryption scheme. At 806, module 220 transmits the encrypted data to the at least one server configured to apply the first operation. For example, addition operations 704 are compatible with PHE, and accordingly the data that serves as an input to addition operations 704 may be encrypted by client device 502 and sent to server 504.

In response to determining, at 802, that the first operation is incompatible with the specific encryption scheme, method 800 advances to 808, where LLM inference module 242 performs the first operation on the data using the at least one client device without encrypting using the specific encryption scheme. In this case, the operation is performed locally. For example, in FIG. 7, initial operations and data 702 may be incompatible with PHE and are performed on client device 502.

In some aspects, the data is input data provided by a user. Accordingly, the at least one client device (e.g., client device 502) may receive a result of the first operation (e.g., operations 704) from the at least one server (e.g., server 504). Client device 502 may then determine a decrypted value from the result using a decryption key (in datastore 221) associated with the specific encryption scheme.

In some aspects, if that is the final result, user interface 210 may output the decrypted value on the at least one client device.

In some aspects, module 220 may also determine whether a second operation (e.g., complex operations 706) performed by the MLM is compatible with the specific encryption scheme. In response to determining that the second operation is incompatible with the specific encryption scheme, LLM inference module 242 may perform the second operation on the decrypted value using the at least one client device without encrypting using the specific encryption scheme.

Suppose that second operation is also a compatible with the specific encryption scheme. In this case, rather than decrypting the first result and performing encryption again, the second operation may also be performed on a result of the first operation applied to the encrypted data.

In various embodiments, the techniques disclosed herein implement a controlled trade-off between security and performance for secure inference in ternary and 1-bit machine learning models by extracting row-level metadata from weight matrices, partitioning such metadata into public and private components, and deliberately revealing the public portion—such as non-zero index sets and, in some configurations, partial sign information—to a server performing homomorphic evaluation. The server derives pattern keys from the public metadata, groups rows that share identical non-zero index patterns, and constructs corresponding pattern descriptors that encode the shared sparsity pattern for each group. For each group, the server computes encrypted pattern-level partial sums once, by homomorphically aggregating encrypted input entries at the indices indicated by the pattern descriptor, and then reuses those encrypted partial sums across all rows in the group to derive row-specific encrypted results or partially processed values. Depending on the security policy and the division of public and private metadata, the client may complete per-row computations using private sign information or scaling after decrypting row-level results or pattern-level partial sums, thereby preserving input/output confidentiality while reducing the number of homomorphic additions relative to per-row evaluation without grouping.

In one aspect, a method includes obtaining a ternary weight matrix for a linear operation of an MLM, determining for each row the set of non-zero column indices and optionally the signs of non-zero elements, generating row metadata, partitioning the metadata into public and private portions according to a security policy, and transmitting the public row metadata in unencrypted form to a server. The method further includes grouping rows into pattern groups based at least in part on the public metadata, generating for each group a pattern descriptor that identifies the common non-zero column indices, encrypting an input vector using a PHE scheme supporting homomorphic addition, and for each pattern group homomorphically summing encrypted input elements selected by the pattern descriptor to form at least one encrypted partial sum used to derive per-row encrypted results. In certain embodiments, the approach supports 1-bit LLMs, designates signs wholly or partially as private, performs pattern grouping offline, and reuses pattern descriptors across multiple encrypted inputs to further amortize computation.

By intentionally revealing limited, policy-governed row-level sparsity patterns, the disclosed system achieves substantive reductions in homomorphic additions through computation sharing at the pattern level, while maintaining confidentiality of user inputs, decrypted outputs, and any private row metadata retained at the client.

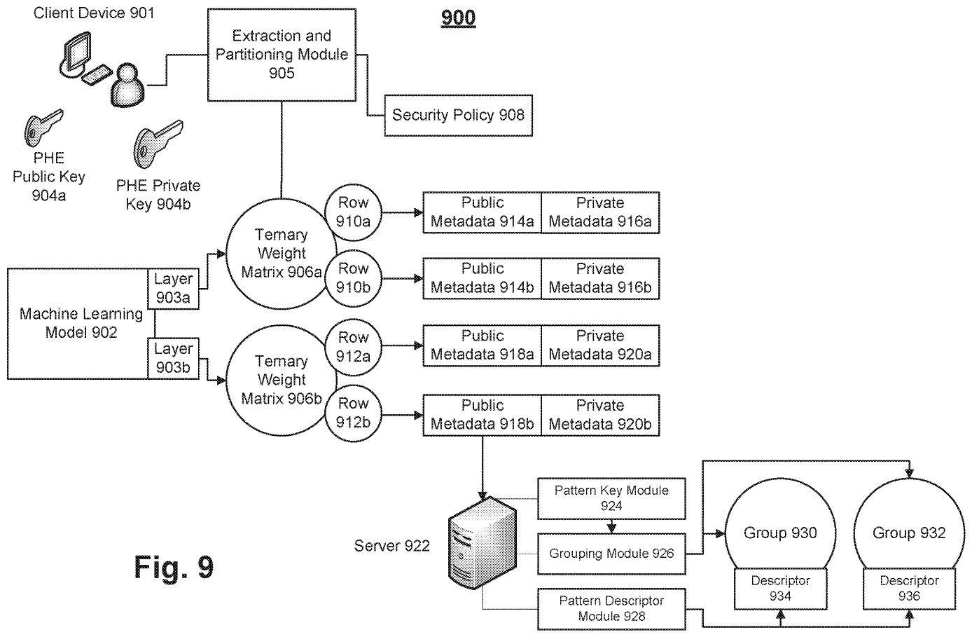

FIG. 9 is a block diagram of a system 900 for secure distributed execution of a MLM using partially homomorphic encryption and ternary weight decomposition.

The process illustrated in FIG. 9 may be organized into a plurality of phases, including a base setup phase, an extraction and partitioning phase, and a controlled exposure and pattern grouping phase, each of which is described in turn below.

The base setup phase involves establishing the foundational components for secure distributed inference. The inputs to this phase may include a trained MLM 902 and a partially homomorphic encryption (PHE) scheme that supports homomorphic addition of ciphertexts. The trained MLM 902 may include at least one linear operation represented by a weight matrix A having elements constrained to the ternary set {−1, 0, +1}.

In some aspects, the MLM 902 may comprise a transformer-based language model, such as a large language model (LLM) configured for natural language understanding or generation tasks. The MLM 902 may be trained on a training dataset comprising a corpus of text data, such as web-crawled documents, books, or domain-specific text collections, using a self-supervised objective such as next-token prediction or masked language modeling.

After initial training with full-precision (e.g., 32-bit floating point) weights, the MLM 902 may undergo a ternary quantization process in which one or more weight matrices are constrained to elements in the set {−1, 0, +1}. The ternary quantization process may involve, for example, applying a threshold-based quantization function that maps each full-precision weight to +1 if the weight exceeds a positive threshold, to −1 if the weight falls below a negative threshold, and to 0 otherwise. In some aspects, the ternary quantization process may further include a fine-tuning step in which the MLM 902 is retrained on the training dataset with the ternary weight constraints enforced, thereby recovering accuracy lost during quantization.

The client device 901 may generate a public key 904a and a private key 904b for the PHE scheme. The client device 901 may comprise, for example, a smartphone, a tablet, a laptop computer, a desktop computer, or any other computing device having at least one processor and a memory. In some aspects, the client device 901 may present a user interface (e.g., a graphical user interface displayed on a touchscreen or monitor) through which a user may provide input data, such as a text prompt or a query, and receive inference results generated by the MLM 902.

The PHE scheme may comprise, for example, a Paillier encryption scheme, an exponential ElGamal scheme, or any other encryption scheme that supports homomorphic addition of ciphertexts. Under the Paillier encryption scheme, for instance, the product of two ciphertexts decrypts to the sum of the corresponding plaintexts, thereby enabling additive homomorphic operations on encrypted data without requiring access to the private key 904b. The client device 901 may use the public key 904a to encrypt data prior to transmission to a remote server and may retain the private key 904b for decryption of results received from the remote server.

The client device 901 may select one or more linear layers 903a, 903b of the MLM 902 for secure distributed execution. The selected linear layers 903a, 903b may include, for example, feed-forward layers, attention projection layers (e.g., query, key, or value projection layers), output projection layers, or any other layers whose operations can be expressed as matrix-vector multiplications involving ternary weight matrices. In the context of a transformer-based MLM, a given transformer block may include a multi-head self-attention mechanism followed by a feed-forward network, each of which may contain one or more linear layers amenable to ternary weight representation. The client device 901 may select the linear layers 903a, 903b based on criteria such as the proportion of near-zero weights in the full-precision representation, the computational cost of the layer, or the sensitivity of the layer to quantization error.

For each selected linear layer, the client device 901 may obtain a corresponding ternary weight matrix A. For instance, a matrix 906a may correspond to layer 903a and a matrix 906b may correspond to layer 903b. Each such ternary weight matrix A may have elements Aᵢⱼ drawn exclusively from the set {−1, 0, +1}.

The base setup phase may yield the PHE public/private key pair (i.e., public key 904a and private key 904b) and one or more ternary weight matrices A (e.g., matrix 906a and matrix 906b) for the selected linear layers.

The extraction and partitioning phase involves extracting structural metadata from each row of a ternary weight matrix A and partitioning such metadata into public and private components. The inputs to this phase may include a ternary weight matrix A with elements Aᵢⱼ∈{−1, 0, +1} and a security/performance policy 908 that defines which aspects of row-level metadata may be exposed to external entities. The security/performance policy 908 may be stored as a configuration file or data structure on the client device 901 and may specify, for each category of row-level metadata, whether that category is classified as public or private. For example, the security/performance policy 908 may specify that non-zero index sets Iᵢ are classified as public (thereby enabling pattern grouping on the server 922) while sign information sᵢⱼ is classified as private (thereby preventing the server 922 from reconstructing the actual weight values). In some aspects, the security/performance policy 908 may be configurable by a user of the client device 901 through the user interface, allowing the user to adjust the trade-off between computational efficiency (achieved by revealing more structural information to the server 922) and data confidentiality (achieved by retaining more structural information at the client device 901). An extraction and partitioning module 905 executing on the client device 901 may perform the operations of this phase.

For each row index i of the weight matrix A, the extraction and partitioning module 905 may determine a non-zero index set Iᵢ={j|Aᵢⱼ≠0}, representing the set of column indices at which row i contains non-zero entries. Optionally, for each index j∈Iᵢ, the extraction and partitioning module 905 may record sign information sᵢⱼ=sign(Aᵢⱼ)∈{+1,−1}, thereby capturing whether each non-zero entry in row i is positive or negative.

The extraction and partitioning module 905 may then construct a row metadata record for each row i. The row metadata record may include at least the non-zero index set Iᵢ and, optionally, the sign information sᵢⱼ for each non-zero entry. In some aspects, the row metadata record may further include additional row-level parameters, such as row-specific scaling factors.

The extraction and partitioning module 905 may apply the security/performance policy 908 to split the row metadata record for each row i into a public row metadata component M^{pub}ᵢ and a private row metadata component M^{priv}ᵢ. The public row metadata M^{pub}ᵢ may include the non-zero index set Iᵢ and, in some embodiments, some or all of the sign information sᵢⱼ. The private row metadata M^{priv}ᵢ may include row-level information that is to be kept confidential at the client device 901. For example, with respect to matrix 906a, row 910a may be decomposed into public metadata 914a and private metadata 916a, and row 910b may be decomposed into public metadata 914b and private metadata 916b. Similarly, with respect to matrix 906b, row 912a may be decomposed into public metadata 918a and private metadata 920a, and row 912b may be decomposed into public metadata 918b and private metadata 920b.

In some aspects, the extraction and partitioning module 905 may optionally represent some of the row metadata in the form of binary masks. For example, a positive mask matrix A⁺ may be constructed such that A⁺ᵢⱼ=1 if Aᵢⱼ=+1 and A⁺ᵢⱼ=0 otherwise. A negative mask matrix A⁻ may be constructed such that A⁻ᵢⱼ=1 if Aᵢⱼ=−1 and A⁻ᵢⱼ=0 otherwise. Some or all of the binary mask information may be assigned to the public row metadata or the private row metadata in accordance with the security/performance policy 908.

The extraction and partitioning phase may yield, for each row i, the public row metadata M^{pub}ᵢ and the private row metadata M^{priv}ᵢ, along with a defined policy describing which row-level information is revealed to external entities versus retained at the client device 901.

The controlled exposure and pattern grouping phase involves the intentional and controlled exposure of public row metadata to a server and the grouping of rows into pattern groups based on shared structural characteristics. The input to this phase may include the public row metadata M^{pub}ᵢ for each row i of the weight matrix A.

The client device 901 may transmit, in unencrypted form, the public row metadata M^{pub}ᵢ for each row i to at least one server 922 over a communication network such as the Internet, a local area network (LAN), or a wireless network. The server 922 may comprise one or more cloud-based computing nodes, an edge computing device, or any other remote computing system having at least one processor and a memory. By transmitting the public row metadata M^{pub}ᵢ in unencrypted form, the client device 901 may intentionally reveal row-level structural information, such as sparsity patterns, to the server 922. The private row metadata M^{priv}ᵢ may be withheld from the server 922 and retained at the client device 901.

The server 922 may then derive, using a pattern key module 924, a pattern key for each row from the public row metadata M^{pub}ᵢ. The pattern key may encode at least the pattern of non-zero column indices of the corresponding row. For example, for a row i having a non-zero index set Iᵢ={2, 5, 11}, the pattern key module 924 may generate a pattern key by sorting the indices and encoding the sorted set as an ordered tuple (2, 5, 11) or by computing a hash value over the sorted index set. In some aspects, the pattern key may further encode publicly available sign information, such that two rows share a pattern key only if both the non-zero column indices and the corresponding publicly known signs are identical. The pattern key may serve as a canonical representation of the sparsity structure of a given row, enabling efficient comparison and grouping of rows having identical non-zero column index patterns.

The server 922 may group, using a grouping module 926, the rows of the weight matrix A into pattern groups such that all rows within a given pattern group share a same pattern key based on their respective public row metadata M^{pub}ᵢ. The grouping module 926 may implement a hash-based grouping algorithm in which the pattern key for each row is used as a hash key, and rows that map to the same hash key are assigned to the same pattern group. For example, if row 3 and row 17 each have a non-zero index set of {2, 5, 11}, the grouping module 926 may assign row 3 and row 17 to a common pattern group. Each pattern group may be assigned a unique pattern identifier (pattern ID).

For each pattern group, the server 922 may generate, using a pattern descriptor module 928, a pattern descriptor. For example, for group 930, module 928 may generate descriptor 934. For group 932, module 928 may generate descriptor 936. The pattern descriptor may include a representation of the non-zero column indices common to all rows in the pattern group and, optionally, publicly exposed sign information derived from the public row metadata M^{pub}ᵢ.

The server 922 may store, for each pattern ID, the corresponding pattern descriptor and a list of associated row indices identifying which rows of the weight matrix A belong to the respective pattern group.

The controlled exposure and pattern grouping phase may yield the pattern groups and corresponding pattern descriptors stored on the server 922. The pattern groups and pattern descriptors may be constructed solely from the public row metadata M^{pub}ᵢ, such that no private row metadata M^{priv}ᵢ is exposed to the server 922 during the pattern grouping process.

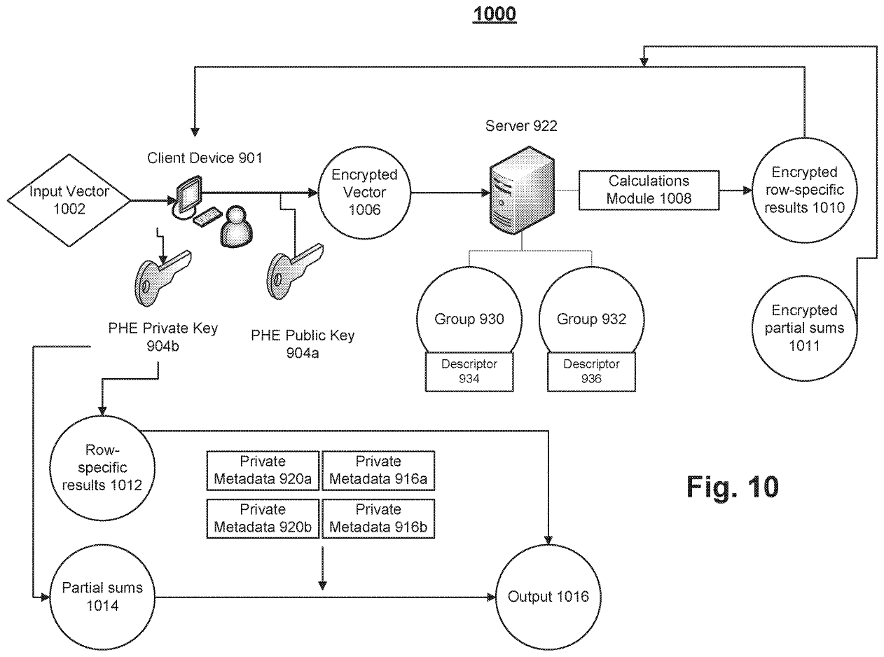

FIG. 10 is a block diagram of a system 1000 for performing secure inference using pattern-based homomorphic evaluation and client-side completion with private row metadata. The process illustrated in FIG. 10 may be organized into a plurality of phases, including a client-side encryption phase, a server-side pattern-based homomorphic evaluation phase, and a client-side decryption and private metadata application phase, each of which is described in turn below.

The client-side encryption phase involves encrypting an input vector at the client device 901 prior to transmission to the server 922. The inputs to this phase may include a plaintext input vector 1002, denoted x=(x₀, . . . , xₙ₋₁), corresponding to the input to a selected linear layer of the MLM 902, and the PHE public key 904a generated during the base setup phase. The plaintext input vector 1002 may represent, for example, an embedding vector corresponding to a token of an input text sequence, a hidden state vector produced by a preceding layer of the MLM 902, or any other intermediate representation within the MLM 902 that serves as input to a linear layer having a ternary weight matrix. In some aspects, the plaintext input vector 1002 may be derived from user-supplied input data, such as a text prompt entered by the user through the user interface of the client device 901.

For each component xⱼ of the plaintext input vector 1002, the client device 901 may compute an encrypted value cⱼ=Enc(xⱼ) using the PHE public key 904a. The encryption operation may be performed element-wise such that each scalar component of the plaintext input vector 1002 is independently encrypted under the PHE scheme.

The client device 901 may then form an encrypted input vector 1006, denoted c=(c₀, . . . , cₙ₋₁), comprising the collection of individually encrypted components produced above.

The client device 901 may transmit the encrypted input vector 1006 c to the server 922. Because each component cⱼ is encrypted under the PHE scheme, the server 922 may not recover the plaintext values xⱼ from the encrypted input vector 1006 without access to the PHE private key 904b.

The client-side encryption phase may yield the encrypted input vector 1006 c, which may be transmitted to and received by the server 922 for subsequent homomorphic evaluation.

The server-side pattern-based homomorphic evaluation phase involves performing pattern-based homomorphic operations on the encrypted input vector 1006 at the server 922, leveraging the pattern groups and pattern descriptors generated during the controlled exposure and pattern grouping phase. The inputs to this phase may include the encrypted input vector 1006 c and the pattern descriptors and pattern groups stored at the server 922.

For each pattern ID p, the server 922 may perform the following operations.

The server 922 may retrieve the pattern descriptor associated with pattern ID p. The pattern descriptor may include a set of non-zero column indices Iₚ, or, where public sign information is available, separate sets I⁺ₚ and I⁻ₚ representing the column indices corresponding to positive and negative weight entries, respectively.

The server 922 may then use the homomorphic addition operation of the PHE scheme to compute pattern-level encrypted partial sums. Where the pattern descriptor consists of a single non-zero index set Iₚ, the server 922 may compute a pattern-level partial sum Pₚ=⊕_{j∈Iₚ}cⱼ, where ⊕ denotes repeated homomorphic addition of ciphertexts. Where the pattern descriptor includes separate positive and negative index sets, the server 922 may compute a positive partial sum S⁺ₚ=⊕_{j∈I⁺ₚ}cⱼ and a negative partial sum S⁻ₚ=⊕_{j∈I⁻ₚ}cⱼ. The pattern-level encrypted partial sums may represent encrypted aggregations of the input vector components corresponding to the non-zero positions shared by all rows within the pattern group.

For each row i belonging to pattern group p, the server 922 may derive an encrypted or partially encrypted result for row i based at least in part on the pattern-level partial sums and any row-level information that is public. When all necessary row-level information is public, the server 922 may compute an encrypted row result yᵢ using only homomorphic operations, without requiring any further client-side completion. When some row-level information is private, the server 922 may prepare pattern-level encrypted partial sums (e.g., Pₚ or (S⁺ₚ, S⁻ₚ)) to be transmitted to the client device 901 for completion using the private row metadata M^{priv}ᵢ.

Because the server 922 may compute the pattern-level partial sums once per pattern and reuse the pattern-level partial sums for all rows sharing the same pattern group p, the total number of homomorphic additions performed by the server 922 may be reduced relative to an approach in which separate sums are computed independently for every row of the weight matrix A. This reduction in homomorphic operations may yield improvements in computational efficiency and inference latency. For example, if a weight matrix A has m rows and k unique sparsity patterns among those rows, the server 922 may compute k pattern-level partial sums rather than m independent row-level sums, resulting in a reduction factor of approximately m/k in the number of homomorphic addition sequences performed.

The server-side pattern-based homomorphic evaluation phase may yield encrypted row-specific results 1010 yᵢ for some rows and/or encrypted pattern-level partial sums for rows requiring later refinement at the client device 901. Results 1010 are generated by a calculations module 1008.

The client-side decryption and private metadata application phase involves decrypting the encrypted results received from the server 922 and applying private row metadata to obtain final plaintext outputs. The inputs to this phase may include encrypted row-specific results 1010 yᵢ and/or encrypted pattern-level partial sums received from the server 922, the PHE private key 904b, and private row metadata M^{priv}ᵢ stored at the client device 901 (e.g., private metadata 916a, 916b, 920a, 920b).

The client device 901 may decrypt, as appropriate, the encrypted results received from the server 922. For rows where the server 922 computed encrypted row-specific results yᵢ, the client device 901 may decrypt such results into plaintext outputs 1012 using the PHE private key 904b. For rows where the server 922 provided encrypted pattern-level partial sums 1011, the client device 901 may decrypt the encrypted pattern-level partial sums 1011 into plaintext partial sums 1014 using the PHE private key 904b.

For rows where private row metadata is required to complete the computation, the client device 901 may apply the private row metadata M^{priv}ᵢ (e.g., private metadata 920a, 920b, 916a, 916b) to the decrypted partial sums 1014 to obtain final row outputs. The application of the private row metadata M^{priv}ᵢ may include, for example, applying private sign information to adjust the polarity of partial sums, applying private scaling factors, or performing other row-specific transformations that were withheld from the server 922 during the controlled exposure and pattern grouping phase.

The client device 901 may combine the per-row outputs into a plaintext output vector 1016, denoted z, representing the result of the selected linear layer of the MLM 902.

The client device 901 may use the plaintext output vector 1016 z as input to subsequent operations on the client device 901, such as applying a non-linear activation function (e.g., a rectified linear unit (ReLU), a Gaussian error linear unit (GELU), or a SiLU activation), performing layer normalization, or feeding the plaintext output vector 1016 z into additional layers of the MLM 902. For example, in a transformer-based MLM, the plaintext output vector 1016 z produced by a first feed-forward layer may be passed through an activation function on the client device 901 and then re-encrypted and transmitted to the server 922 for processing by a subsequent feed-forward layer. Alternatively, the client device 901 may re-encrypt the plaintext output vector 1016 z for further PHE-compatible operations on the server 922. Once the MLM 902 has processed all layers for a given input, the client device 901 may present the final inference result (e.g., a generated text response, a classification label, or a set of ranked predictions) to the user through the user interface of the client device 901.

The client-side decryption and private metadata application phase may yield the plaintext output vector 1016 z, which may be obtained via a procedure that deliberately reveals row-level sparsity patterns to optimize the efficiency of PHE operations while retaining private row-level information at the client device 901.

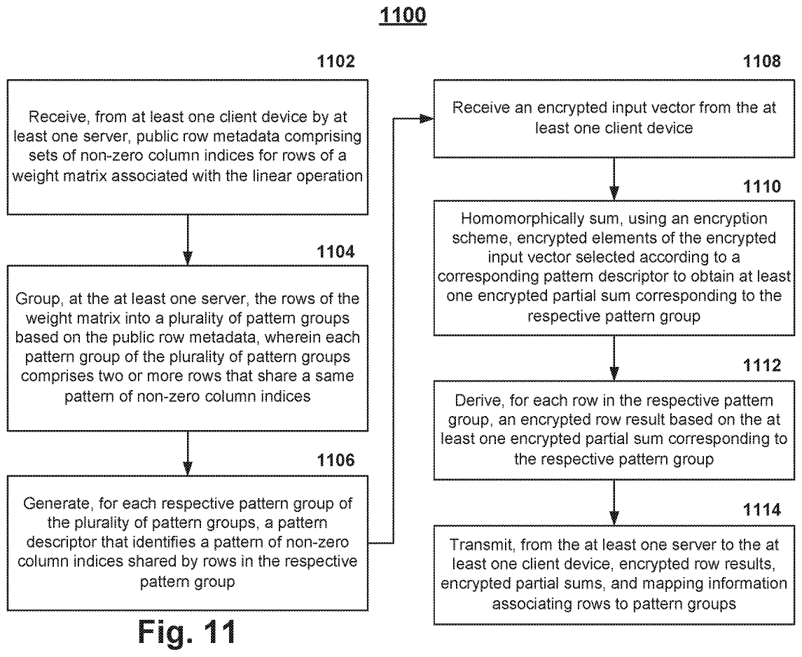

FIG. 11 is a flowchart of a method 1100 for securely computing at least a portion of a linear operation of an MLM.

For example, consider a 1-bit LLM whose feed-forward layer uses a 4×6 ternary weight matrix A with entries drawn from {−1, 0, +1}. A client device holds a plaintext input vector x=(x₀, x₁, x₂, x₃, x₄, x₅) and needs to compute the matrix-vector product z=A·x securely, without revealing x to the server and without the server revealing A to the client. The method that follows shows how exposing only the positions of the non-zero entries—rather than their signs or the input values—enables the server to share computation across rows that have identical sparsity patterns, thereby reducing the total number of homomorphic additions and improving inference latency relative to a naïve per-row encrypted evaluation.

At 1102, at least one server receives, from at least one client device, public row metadata comprising sets of non-zero column indices for rows of a weight matrix associated with the linear operation.

Suppose the weight matrix A is:

| Row | Col 0 | Col 1 | Col 2 | Col 3 | Col 4 | Col 5 |
|---|---|---|---|---|---|---|
| 0 | 0 | +1 | 0 | 0 | −1 | 0 |
| 1 | +1 | 0 | 0 | −1 | 0 | 0 |
| 2 | 0 | +1 | 0 | 0 | −1 | 0 |
| 3 | +1 | 0 | 0 | −1 | 0 | 0 |

The client's extraction and partitioning module 905 determines the non-zero index sets: I₀={1, 4}, I₁={0, 3}, I₂={1, 4}, I₃={0, 3}. Under the security policy, the client designates the non-zero index sets as public row metadata and the sign information (e.g., s_{0,1=+1}, s_{0,4=-1}) as private row metadata. The client transmits the public row metadata—{I₀, I₁, I₂, I₃}—in unencrypted form to the server. This controlled exposure reveals only which columns participate in each row, not the sign or magnitude of the weights, and is far less information than exposing the full weight matrix. Conventional approaches that keep all row structure secret force the server to treat every row independently, precluding any computation sharing across rows.

At 1104, the grouping module 926 groups, at the at least one server, the rows of the weight matrix into a plurality of pattern groups based on the public row metadata, wherein each pattern group of the plurality of pattern groups comprises two or more rows that share a same pattern of non-zero column indices.

For example, the server's grouping module 926 examines the received public row metadata and observes that rows 0 and 2 both have I={1, 4}, while rows 1 and 3 both have I={0, 3}. The grouping module 926 therefore creates two pattern groups:

$$Pattern Group {P}_{1} = \{ Row 0 , Row 2 \} - both share non - zero index set \{ 1 , 4 \}$$

$$Pattern Group {P}_{2} = \{ Row 1 , Row 3 \} - both share non - zero index set \{ 0 , 3 \}$$

Without this grouping step, the server would need to compute four separate encrypted row sums (one per row). With grouping, the server only needs to compute two pattern-level partial sums (one per group), cutting the number of homomorphic addition sequences in half. In realistic weight matrices with thousands of rows and many repeated sparsity patterns, this reduction factor (m/k, where m is the number of rows and k the number of unique patterns) can be very large, yielding a corresponding improvement in wall-clock time for encrypted inference.

In some aspects, the server 922 groups the rows based on the public row metadata by computing a pattern key for each row from the public row metadata that encodes at least the pattern of the non-zero column indices, and assigning rows having a same pattern key to a same pattern group.

Continuing with the running example, the pattern key module 924 computes a pattern key for each row by sorting the non-zero indices and encoding them as an ordered tuple:

$$Row 0 \to key = ( 1 , 4 )$$

$$Row 1 \to key = ( 0 , 3 )$$

$$Row 2 \to key = ( 1 , 4 )$$

$$Row 3 \to key = ( 0 , 3 )$$

Rows sharing the same key are assigned to the same group: rows 0 and 2 map to key (1, 4), and rows 1 and 3 map to key (0, 3). Alternatively, the pattern key module 924 could compute a hash value over the sorted index set (e.g., hash((1, 4))→0xA3F1) to enable O(1) average-time lookup in a hash table. This canonical-key approach enables the server to group rows in time proportional to the number of rows, which is far more efficient than pairwise comparison of all row patterns.

At 1106, the pattern descriptor module 928 generates, for each respective pattern group of the plurality of pattern groups, a pattern descriptor that identifies a pattern of non-zero column indices shared by rows in the respective pattern group.

For example, the pattern descriptor module 928 produces the following descriptors:

$$Descriptor for {P}_{1} \text{:} non - zero column indices = \{ 1 , 4 \}$$

$$Descriptor for {P}_{2} \text{:} non - zero column indices = \{ 0 , 3 \}$$

If sign information were also designated as public under the security policy, the descriptor could further separate positive and negative positions—for instance, P₁ might record I⁺={1} and I⁻={4}. The pattern descriptor acts as a compact instruction set telling the server exactly which encrypted input elements to aggregate for all rows in the group. Because the descriptor is computed once and stored, the server avoids re-scanning row metadata on every inference call, supporting amortized efficiency gains across repeated invocations of the MLM.

At 1108, the server 922 receives an encrypted input vector from the at least one client device.

For example, the client device 901 holds the plaintext input vector x=(x₀, x₁, x₂, x₃, x₄, x₅)=(3.0, 1.5, 0.7, 2.0, 4.0, 0.5). Using the PHE public key 904a and, for instance, the Paillier encryption scheme, the client encrypts each element independently:

$${c}_{0} = Enc ( 3. ) , {c}_{1} = Enc ( 1.5 ) , {c}_{2} = Enc ( 0.7 ) , {c}_{3} = Enc ( 2.0 ) , {c}_{4} = Enc ( 4.0 ) , {c}_{5} = Enc ( 0.5 )$$

The client transmits the encrypted input vector c=(c₀, c₁, c₂, c₃, c₄, c₅) to the server. At no point does the server learn the plaintext values; the server sees only ciphertexts. This element-wise encryption is compatible with the PHE addition property, which will allow the server to homomorphically sum selected ciphertexts in the next steps without decryption.

Steps 1110 and 1112 are performed for each respective pattern group of the plurality of pattern groups.

In the running example, the server iterates over two pattern groups (P₁ and P₂), performing the encrypted partial sum computation (step 1110) and the per-row derivation (step 1112) for each group in turn.

At 1110, the server 922 homomorphically sums, using an encryption scheme, encrypted elements of the encrypted input vector selected according to a corresponding pattern descriptor to obtain at least one encrypted partial sum corresponding to the respective pattern group.

For example, for pattern group P₁ (non-zero column indices {1, 4}), the server selects ciphertexts c₁ and c₄ (corresponding to x₁ and x₄) and computes the pattern-level partial sum using the PHE addition operation:

$${P\_P}_{1} = {c}_{1} ⊕ {c}_{4} = Enc ( {x}_{1} + {x}_{4} ) = Enc ( 1.5 + 4.0 ) = Enc ( 5.5 )$$

For pattern group P₂ (non-zero column indices {0, 3}), the server selects c₀ and c₃ and computes:

$${P\_P}_{2} = {c}_{0} ⊕ {c}_{3} = Enc ( {x}_{0} + {x}_{3} ) = Enc ( 3.0 + 2.0 ) = Enc ( 5.0 )$$

Here “⊕” denotes the homomorphic addition operation (e.g., modular multiplication of Paillier ciphertexts, which decrypts to the sum of the plaintexts). The server has performed only two homomorphic addition sequences (one per group) instead of four (one per row). This is the core computational savings: by sharing the addition work among rows that have the same non-zero pattern, the system avoids redundant ciphertext aggregations that would otherwise dominate inference time.

In some aspects, the encryption scheme is a partially homomorphic encryption (PHE) scheme.

For example, in the Paillier PHE scheme used in this example, for any two ciphertexts Enc(a) and Enc(b), the product Enc(a)·Enc(b) mod n² decrypts to a+b. This additive homomorphism is sufficient for evaluating all of the linear layer's addition operations on encrypted data. A fully homomorphic encryption (FHE) scheme would additionally support multiplication on ciphertexts but at much higher computational cost; because 1-bit linear layers require only additions and sign changes (no multiplications), PHE provides a more efficient alternative.

In some aspects, the server 922 homomorphically sums for each pattern group by applying an addition operation defined by the encryption scheme to ciphertexts associated with encrypted input vector elements at the non-zero column indices indicated by the pattern descriptor for the respective pattern group, while omitting ciphertexts associated with zero elements of the weight matrix.

For pattern group P₁ with descriptor {1, 4}, the server touches only c₁ and c₄ and entirely skips c₀, c₂, c₃, and c₅ because columns 0, 2, 3, and 5 have zero weight entries for all rows in P₁. In pseudocode:

```
FOR each pattern group P:
  descriptor ← pattern_descriptors[P]
  partial_sum ← identity_ciphertext // Enc(0)
  FOR each column index j IN descriptor.nonzero_indices:
    partial_sum ← HE_Add(partial_sum, c[j])
  store partial_sum for group P
```

Because the encrypted input vector c is indexed from 0 (i.e., c₀ through c₅), the column index j drawn from the pattern descriptor maps directly to the corresponding ciphertext c[j]=cⱼ without any index offset.

By omitting zero-position ciphertexts, the server avoids unnecessary homomorphic additions. In a naïve approach that does not exploit sparsity, the server would perform n−1 additions per row (where n=6 is the vector length). Here, each group requires only |Iₚ|−1 additions (e.g., 1 addition for |{1, 4}|=2 elements), and the result is shared across all rows in the group.

At 1112, the server 922 derives, for each row in the respective pattern group, an encrypted row result based on the at least one encrypted partial sum corresponding to the respective pattern group.

For example, whether the server can fully derive the encrypted row result depends on whether sign information is public or private.

Scenario A—Signs are public: Suppose the security policy designates sign information as public. The descriptor for P₁ could record I⁺={1} and I⁻={4}. The server computes separate partial sums: S⁺=c₁=Enc(1.5) and S⁻=c₄=Enc(4.0). For any row in P₁ (e.g., Row 0, which has weights [0, +1, 0, 0,−1, 0]), the server derives:

$${y}_{0} = {S}^{+} ⊖ {S}^{-} = Enc ( 1.5 - 4.0 ) = Enc ( - 2.5 )$$

where ⊖ represents homomorphic subtraction (raising the ciphertext to the modular inverse in Paillier). The server can complete the row result entirely, with no client-side completion needed.

Scenario B—Signs are private: When sign information is kept private, the server cannot distinguish positive from negative positions within the group. The server sends the undifferentiated partial sum P_P₁=Enc(5.5) to the client, along with the mapping {Row 0→P₁, Row 2→P₁}. The client then applies the private sign metadata locally after decryption. In Scenario B, the server does less per-row work, but the client takes on the responsibility of applying signs—still, the total homomorphic work on the server side is reduced because the partial sum was computed only once per group.

At 1114, the at least one server transmits, to the at least one client device, encrypted row results, encrypted partial sums, and mapping information associating rows to pattern groups.

In Scenario A (signs public), the server transmits fully computed encrypted row results: {yₒ=Enc(−2.5), y₁=Enc(1.0), y₂=Enc(−2.5), y₃=Enc(1.0)}, together with the mapping {Row 0→P₁, Row 1→P₂, Row 2→P₁, Row 3→P₂}. In Scenario B (signs private), the server transmits the pattern-level partial sums {P_P₁=Enc(5.5), P_P₂=Enc(5.0)} and the same mapping. In either case, the transmitted data is substantially smaller and faster to produce than if the server had computed and transmitted independent encrypted sums for each of the four rows.

In some aspects, the at least one client device is configured to receive, from the at least one server, the encrypted row results, the encrypted partial sums, and the mapping information associating rows to pattern groups. The client device further decrypts at least one of the encrypted row results or the encrypted partial sums, and generates, using private row metadata, a plaintext output element of the linear operation for a corresponding row.

Example (Scenario B—signs private): The client receives P_P₁=Enc(5.5) and decrypts it using the PHE private key 904b to obtain the plaintext partial sum 5.5. The plaintext partial sum represents the unsigned aggregate x₁+x₄=1.5+4.0=5.5. Because the client originally encrypted the input vector and therefore retains the individual plaintext values x₀ through x₅ locally, the client can apply the private sign metadata for Row 0 (s_{0,1}=+1, s_{0,4}=−1) directly to the corresponding plaintext input values:

$${z}_{0} = ( + 1 ) \cdot {x}_{1} + ( - 1 ) \cdot {x}_{4} = 1.5 - 4.0 = - 2.5$$

The client does not need to recover the individual summands from the decrypted partial sum; the partial sum serves as a verification check, while the signed row output is computed from the plaintext values already held at the client.

The client similarly processes Row 2 (same pattern group P₁, same private signs s_{2,1}=+1, a_{2,4}=−1) to obtain z₂=(+1)·x₁+(−1)·x₄=1.5−4.0=−2.5. For pattern group P₂, the client decrypts P_P₂=Enc(5.0) to obtain the plaintext partial sum 5.0 and applies the private signs for Rows 1 and 3 (s_{1,0}=+1, s_{1,3}=−1), yielding z₁=(+1)·x₀+(−1)·x₃=3.0−2.0=1.0 and z₃=1.0. This client-side completion step ensures that sign information—and therefore the actual weight values—are never exposed to the server.

In some aspects, the at least one client device is configured to determines, for each respective row of the weight matrix, a set of column indices corresponding to non-zero elements to obtain row-level sparsity information. The client device generates, for each respective row, row metadata that includes the row-level sparsity information.

For example, before any data is sent to the server, the extraction and partitioning module 905 on the client scans each row of A:

```
FOR each row i in A:
  l_i ← {j : A[i][j] ≠ 0}
  s_i ← {j : sign(A[i][j]) for j in l_i}
  row_metadata[i] ← (l_i, s_i)
```

For the running example, this yields: row_metadata[0]=({1,4}, {+1,−1}), row_metadata[1]=({0,3}, {+1,−1}), and so on. By extracting sparsity information at the client, the system ensures that the server never needs access to the raw weight matrix—improving security by minimizing the attack surface while still enabling the server to exploit structural redundancy.

In some aspects, the elements of the weight matrix comprise values in {−1, 0, +1}, such that the non-zero elements have magnitude one.

For example, in the weight matrix A, every entry is exactly −1, 0, or +1. This ternary constraint means that the matrix-vector product z=A·x involves no floating-point multiplications-only additions and sign changes. This property is what makes PHE (which supports only addition) a viable encryption scheme for the linear layer; a conventional dense matrix with arbitrary floating-point weights would require multiplication operations on ciphertexts, necessitating the much more expensive FHE. The ternary format thus enables a fundamental improvement in encrypted computation speed.

In some aspects, for each row of the weight matrix, the extraction and partitioning module 905 determines a sign for each non-zero element, and wherein the row metadata further includes sign information associated with non-zero positions in the row.

For example, for Row 0 of A, the extraction and partitioning module 905 records: position 1 has sign +1, position 4 has sign −1. The full sign record for the matrix is:

| Row | Position → Sign |
|---|---|
| 0 | 1 → +1, 4 → −1 |
| 1 | 0 → +1, 3 → −1 |
| 2 | 1 → +1, 4 → −1 |
| 3 | 0 → +1, 3 → −1 |

Whether this sign information is classified as public or private is determined by the security policy in the next step. Recording signs separately from sparsity positions enables fine-grained control over what the server learns: sparsity patterns alone reveal structural redundancy (enabling grouping), while signs reveal actual weight values (which may be more sensitive).

In some aspects, the at least one client device is configured to partition, for each respective row, the row metadata into the public row metadata and private row metadata according to a security policy. In some aspects, partitioning the row metadata into the public row metadata and the private row metadata comprises designating the row-level sparsity information as part of the public row metadata, and designating at least a portion of sign information associated with non-zero positions in the respective row as part of the private row metadata.

For example, under a conservative security policy 908, the client partitions as follows:

| FOR each row i: | |
|---|---|
| M_pub[i] ← l_i | // non-zero column indices (public) |
| M_priv[i] ← s_i | // sign information (private) |

So for Row 0: M_pub[0]={1, 4} and M_priv[0]={+1,−1}. A more permissive policy could also designate signs as public (see paragraph [0019]), which would allow the server to fully compute encrypted row results without client-side completion. This configurable partition is an improvement over conventional all-or-nothing encryption approaches because it allows system operators to tune the security/performance trade-off to their specific deployment requirements.

The client device then transmits the public row metadata to the at least one server in unencrypted form while retaining the private row metadata locally.

For example, the client sends the following unencrypted payload to the server:

### Public Row Metadata:

Row 0: {1, 4}
Row 1: {0, 3}
Row 2: {1, 4}
Row 3: {0, 3}

The private sign vectors M_priv[0] through M_priv[3] remain on the client's local storage and are never transmitted. Transmitting the public metadata in plaintext (rather than encrypted) is intentional: it allows the server to read and process the sparsity patterns directly, which is necessary for the grouping and descriptor generation steps. The controlled exposure of this limited structural information represents a deliberate, policy-governed trade-off that enables significant computational savings while maintaining confidentiality of the weight values themselves.

In some aspects, the security policy designates both the row-level sparsity information and the sign information as the public row metadata. The server 922 derives the encrypted row result by using the sign information and the encrypted partial sum to compute, using homomorphic operations defined by the encryption scheme, the encrypted row result without using the private row metadata.

Example: Under a fully public policy, the client sends both the non-zero indices and the signs to the server. For P₁ (rows 0 and 2), the server now knows I⁺={1} and I⁻={4} and computes:

$${S}^{+} = {c}_{1} = Enc ( 1.5 )$$

$${S}^{-} = {c}_{4} = Enc ( 4. )$$

$${y}_{0} = {y}_{2} = {S}^{+} ⊖ {S}^{-} = Enc ( 1.5 - 4.0 ) = Enc ( - 2.5 )$$

The server completes the entire row computation without any client-side completion step. This eliminates a round-trip of communication and local computation on the client, further improving inference latency. The trade-off is that the server now knows not only which positions are non-zero but also whether each non-zero weight is +1 or −1—effectively revealing the entire weight matrix to the server. Whether this trade-off is acceptable depends on the deployment context and the sensitivity of the model weights.

In some aspects, the MLM is a 1-bit large language model (LLM), and the weight matrix represents weights of a 1-bit linear layer of the 1-bit LLM.

The running example's 4×6 ternary matrix A could represent a small feed-forward layer in a 1-bit LLM such as a BitNet-style model. In a production-scale 1-bit LLM, the weight matrix might be 4096×4096 or larger, but all entries remain in {−1, 0, +1}. Because 1-bit linear layers replace floating-point multiplication with sign changes and additions, the entire matrix-vector product can be evaluated under PHE without any homomorphic multiplication—an operation that PHE does not support. This architectural compatibility between 1-bit quantization and PHE is what makes the disclosed pattern-grouping technique viable: it would not apply to conventional full-precision layers that require multiplicative operations.

In some aspects, the server 922 performs, at the at least one server, the grouping of rows and the generating of the pattern descriptors as an offline preprocessing operation using the public row metadata. The server 922 reuses the pattern descriptors to compute the encrypted partial sums for a plurality of different encrypted input vectors associated with a plurality of invocations of the MLM.

For example, the weight matrix A does not change between inference calls—only the input vector x changes. Therefore, the server performs the grouping and descriptor generation once (offline), and stores the results:

```
OFFLINE PHASE (run once):
  Receive public row metadata
  Compute pattern keys → {(1,4), (0,3), (1,4), (0,3)}
  Group rows → P₁ = {0,2}, P₂ = {1,3}
  Generate descriptors → desc[P₁] = {1,4}, desc[P₂] = {0,3}
  Store groups and descriptors
ONLINE PHASE (run per input):
  Receive encrypted input vector c
  FOR each pattern group P:
    partial_sum[P] ← HE_Add over c[j] for j in desc[P]
  Derive and transmit results
```

If the LLM is invoked 1,000 times (e.g., 1,000 user queries), the grouping and descriptor generation occur only once, while the encrypted partial sum computation is repeated 1,000 times using the precomputed descriptors. This amortization of the offline phase across many invocations further reduces the average per-query computational cost, improving throughput for high-volume inference services.

In some aspects, the at least one client device is configured to encrypt a plurality of elements of an input vector associated with the linear operation using the encryption scheme to obtain the encrypted input vector, and transmit the encrypted input vector to the at least one server.

For example, for each new inference request, the client encrypts the current input vector element-wise:

FOR j = 0 TO n-1:
c[j] ← PHE_Encrypt(public_key, x[j])
encrypted_vector ← (c[0], c[1], ..., c[n-1])
Transmit encrypted_vector to server

In the running example, the client encrypts x=(3.0, 1.5, 0.7, 2.0, 4.0, 0.5) into six ciphertexts and sends them to the server. The server can then immediately begin computing pattern-level partial sums using the precomputed descriptors from the offline phase. Because each element is independently encrypted, the server can select and aggregate any subset of ciphertexts corresponding to a pattern descriptor without needing to decrypt or re-encrypt. This element-wise encryption design is what enables the selective, pattern-driven summation that lies at the heart of the disclosed efficiency improvement.

In some aspects, the disclosed public row metadata is used as routing metadata that determines which encrypted input elements are directed into a shared homomorphic accumulation pipeline. Rows associated with a same index pattern may therefore share a same encrypted partial sum or a same family of encrypted partial sums, thereby reducing repeated homomorphic additions otherwise performed independently for each row.

In some aspects, the row metadata is partitioned according to a disclosure policy that designates non-zero index positions as public while retaining other row-specific information locally at the client. The retained local information may include signs, scaling factors, threshold values, row-completion formulas, or other metadata sufficient to reconstruct a final row result after decryption.

Public row metadata may be represented as ordered index sets, binary masks, sparse lists, compressed descriptors, canonicalized tuples, or hashed pattern identifiers, provided that equivalent row patterns can be grouped for shared encrypted partial-sum computation.

In some aspects, the public row metadata may be used to route encrypted elements of the encrypted input vector to a shared homomorphic partial-sum computation associated with a pattern group. For example, when the server 922 receives the public row metadata indicating that a set of rows share a common non-zero index pattern, the server may direct the corresponding encrypted input elements to a single, shared partial-sum computation rather than performing separate summations for each row. The resulting shared homomorphic partial-sum computation may then be reused for a plurality of rows that are mapped to the same pattern group, thereby reducing the total number of homomorphic addition operations required. This routing mechanism allows the server to efficiently multiplex encrypted ciphertext elements across rows that exhibit identical sparsity structures, achieving substantial computational savings without compromising the confidentiality of the underlying input values or the private portions of the weight matrix.

In some aspects, the public row metadata comprises the non-zero column indices for each row of the weight matrix, while private row metadata is retained at the at least one client device. The private row metadata may comprise at least one of: sign information for one or more non-zero entries in the corresponding row, row-specific scaling information that determines magnitude adjustments for individual row computations, or row-specific completion logic that specifies how partial results should be combined to produce final row outputs. Under this partitioning, the at least one server computes one or more encrypted partial sums using only the public row metadata, which identifies which input vector positions to aggregate but does not reveal the polarities or magnitudes of the weight values. The at least one client device then completes a row output using the private row metadata after decrypting the encrypted partial sums received from the server. For example, the client may apply private sign information to correctly assign positive or negative contributions to the decrypted partial sum, apply row-specific scaling factors to adjust the magnitude of intermediate results, or execute completion logic that combines multiple partial sums according to row-specific rules. This division of labor between the server and the client ensures that sign information, scaling parameters, and completion rules remain confidential while still enabling the server to perform the bulk of the homomorphic computation.

In some aspects, the at least one server may store pattern descriptors and row-to-pattern mappings generated from the public row metadata and may reuse the stored pattern descriptors and the row-to-pattern mappings across a plurality of encrypted input vectors associated with a plurality of invocations of the machine learning model. Because the weight matrix of a trained MLM typically remains static across inference calls, the server may perform the pattern grouping and descriptor generation operations once as an offline preprocessing step and persist the resulting data structures in a data store. When subsequent encrypted input vectors are received from the client device for additional invocations of the MLM, the server may retrieve the precomputed pattern descriptors and row-to-pattern mappings from the data store and apply them directly to the new encrypted input vector without repeating the grouping analysis. This amortization of the pattern analysis across multiple invocations reduces the per-query computational overhead and improves throughput for high-volume inference services. In practice, a deployment processing thousands of user queries may incur the cost of pattern extraction and grouping only once, while benefiting from the computational savings of shared partial-sum computation on every subsequent query.

It should be noted that the relevant PHE or FHE operations described in the present disclosure may be performed using a dedicated hardware accelerator, including an application-specific integrated circuit (ASIC). The ASIC may include on-chip memory, or alternatively may use memory located outside the chip and allocated for such operations.

FIG. 12 is a block diagram illustrating a computer system 20 on which aspects of systems and methods for providing a secure LLM deployment in an enterprise may be implemented. The computer system 20 can be in the form of multiple computing devices, or in the form of a single computing device, for example, a desktop computer, a notebook computer, a laptop computer, a mobile computing device, a smart phone, a tablet computer, a server, a mainframe, an embedded device, and other forms of computing devices.

As shown, the computer system 20 includes a central processing unit (CPU) 21, a system memory 22, and a system bus 23 connecting the various system components, including the memory associated with the central processing unit 21. The system bus 23 may comprise a bus memory or bus memory controller, a peripheral bus, and a local bus that is able to interact with any other bus architecture. Examples of the buses may include PCI, ISA, PCI-Express, HyperTransport™, InfiniBand™, Serial ATA, I²C, and other suitable interconnects. The central processing unit 21 (also referred to as a processor) can include a single or multiple sets of processors having single or multiple cores. The processor 21 may execute one or more computer-executable code implementing the techniques of the present disclosure. The system memory 22 may be any memory for storing data used herein and/or computer programs that are executable by the processor 21. The system memory 22 may include volatile memory such as a random access memory (RAM) 25 and non-volatile memory such as a read only memory (ROM) 24, flash memory, etc., or any combination thereof. The basic input/output system (BIOS) 26 may store the basic procedures for transfer of information between elements of the computer system 20, such as those at the time of loading the operating system with the use of the ROM 24.

The computer system 20 may include one or more storage devices such as one or more removable storage devices 27, one or more non-removable storage devices 28, or a combination thereof. The one or more removable storage devices 27 and non-removable storage devices 28 are connected to the system bus 23 via a storage interface 32. In an aspect, the storage devices and the corresponding computer-readable storage media are power-independent modules for the storage of computer instructions, data structures, program modules, and other data of the computer system 20. The system memory 22, removable storage devices 27, and non-removable storage devices 28 may use a variety of computer-readable storage media. Examples of computer-readable storage media include machine memory such as cache, SRAM, DRAM, zero capacitor RAM, twin transistor RAM, eDRAM, EDO RAM, DDR RAM, EEPROM, NRAM, RRAM, SONOS, PRAM; flash memory or other memory technology such as in solid state drives (SSDs) or flash drives; magnetic cassettes, magnetic tape, and magnetic disk storage such as in hard disk drives or floppy disks; optical storage such as in compact disks (CD-ROM) or digital versatile disks (DVDs); and any other medium which may be used to store the desired data and which can be accessed by the computer system 20.

The system memory 22, removable storage devices 27, and non-removable storage devices 28 of the computer system 20 may be used to store an operating system 35, additional program applications 37, other program modules 38, and program data 39. The computer system 20 may include a peripheral interface 46 for communicating data from input devices 40, such as a keyboard, mouse, stylus, game controller, voice input device, touch input device, or other peripheral devices, such as a printer or scanner via one or more I/O ports, such as a serial port, a parallel port, a universal serial bus (USB), or other peripheral interface. A display device 47 such as one or more monitors, projectors, or integrated display, may also be connected to the system bus 23 across an output interface 48, such as a video adapter. In addition to the display devices 47, the computer system 20 may be equipped with other peripheral output devices (not shown), such as loudspeakers and other audiovisual devices.

The computer system 20 may operate in a network environment, using a network connection to one or more remote computers 49. The remote computer (or computers) 49 may be local computer workstations or servers comprising most or all of the aforementioned elements in describing the nature of a computer system 20. Other devices may also be present in the computer network, such as, but not limited to, routers, network stations, peer devices or other network nodes. The computer system 20 may include one or more network interfaces 51 or network adapters for communicating with the remote computers 49 via one or more networks such as a local-area computer network (LAN) 50, a wide-area computer network (WAN), an intranet, and the Internet. Examples of the network interface 51 may include an Ethernet interface, a Frame Relay interface, SONET interface, and wireless interfaces.

Aspects of the present disclosure may be a system, a method, and/or a computer program product. The computer program product may include a computer readable storage medium (or media) having computer readable program instructions thereon for causing a processor to carry out aspects of the present disclosure.

The computer readable storage medium can be a tangible device that can retain and store program code in the form of instructions or data structures that can be accessed by a processor of a computing device, such as the computing system 20. The computer readable storage medium may be an electronic storage device, a magnetic storage device, an optical storage device, an electromagnetic storage device, a semiconductor storage device, or any suitable combination thereof. By way of example, such computer-readable storage medium can comprise a random access memory (RAM), a read-only memory (ROM), EEPROM, a portable compact disc read-only memory (CD-ROM), a digital versatile disk (DVD), flash memory, a hard disk, a portable computer diskette, a memory stick, a floppy disk, or even a mechanically encoded device such as punch-cards or raised structures in a groove having instructions recorded thereon. As used herein, a computer readable storage medium is not to be construed as being transitory signals per se, such as radio waves or other freely propagating electromagnetic waves, electromagnetic waves propagating through a waveguide or transmission media, or electrical signals transmitted through a wire.

Computer readable program instructions described herein can be downloaded to respective computing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network interface in each computing device receives computer readable program instructions from the network and forwards the computer readable program instructions for storage in a computer readable storage medium within the respective computing device.

Computer readable program instructions for carrying out operations of the present disclosure may be assembly instructions, instruction-set-architecture (ISA) instructions, machine instructions, machine dependent instructions, microcode, firmware instructions, state-setting data, or either source code or object code written in any combination of one or more programming languages, including an object oriented programming language, and conventional procedural programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a LAN or WAN, or the connection may be made to an external computer (for example, through the Internet). In some aspects, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

In various aspects, the systems and methods described in the present disclosure can be addressed in terms of modules. The term “module” as used herein refers to a real-world device, component, or arrangement of components implemented using hardware, such as by an application specific integrated circuit (ASIC) or FPGA, for example, or as a combination of hardware and software, such as by a microprocessor system and a set of instructions to implement the module's functionality, which (while being executed) transform the microprocessor system into a special-purpose device. A module may also be implemented as a combination of the two, with certain functions facilitated by hardware alone, and other functions facilitated by a combination of hardware and software. In certain implementations, at least a portion, and in some cases, all, of a module may be executed on the processor of a computer system (such as the one described in greater detail in FIG. 8 above). Accordingly, each module may be realized in a variety of suitable configurations, and should not be limited to any particular implementation exemplified herein.

In the interest of clarity, not all of the routine features of the aspects are disclosed herein. It would be appreciated that in the development of any actual implementation of the present disclosure, numerous implementation-specific decisions must be made in order to achieve the developer's specific goals, and these specific goals will vary for different implementations and different developers. It is understood that such a development effort might be complex and time-consuming, but would nevertheless be a routine undertaking of engineering for those of ordinary skill in the art, having the benefit of this disclosure.

Furthermore, it is to be understood that the phraseology or terminology used herein is for the purpose of description and not of restriction, such that the terminology or phraseology of the present specification is to be interpreted by the skilled in the art in light of the teachings and guidance presented herein, in combination with the knowledge of those skilled in the relevant art(s). Moreover, it is not intended for any term in the specification or claims to be ascribed an uncommon or special meaning unless explicitly set forth as such.

The various aspects disclosed herein encompass present and future known equivalents to the known modules referred to herein by way of illustration. Moreover, while aspects and applications have been shown and described, it would be apparent to those skilled in the art having the benefit of this disclosure that many more modifications than mentioned above are possible without departing from the inventive concepts disclosed herein.

1. A method for securely computing at least a portion of a linear operation of a machine learning model (MLM), the method comprising:
receiving, from at least one client device by at least one server, public row metadata comprising sets of non-zero column indices for rows of a weight matrix associated with the linear operation;
grouping, at the at least one server, the rows of the weight matrix into a plurality of pattern groups based on the public row metadata, wherein each pattern group of the plurality of pattern groups comprises two or more rows that share a same pattern of non-zero column indices;
generating, for each respective pattern group of the plurality of pattern groups, a pattern descriptor that identifies a pattern of non-zero column indices shared by rows in the respective pattern group;
receiving an encrypted input vector from the at least one client device;
for each respective pattern group of the plurality of pattern groups:
homomorphically summing, using an encryption scheme, encrypted elements of the encrypted input vector selected according to a corresponding pattern descriptor to obtain at least one encrypted partial sum corresponding to the respective pattern group; and
deriving, for each row in the respective pattern group, an encrypted row result based on the at least one encrypted partial sum corresponding to the respective pattern group; and
transmitting, from the at least one server to the at least one client device, encrypted row results, encrypted partial sums, and mapping information associating rows to pattern groups.

2. The method of claim 1, wherein the at least one client device is configured to:
receive, from the at least one server, the encrypted row results, the encrypted partial sums, and the mapping information associating rows to pattern groups;
decrypt at least one of the encrypted row results or the encrypted partial sums; and
generate, using private row metadata, a plaintext output element of the linear operation for a corresponding row.

3. The method of claim 1, wherein the at least one client device is configured to:
determine, for each respective row of the weight matrix, a set of column indices corresponding to non-zero elements to obtain row-level sparsity information; and
generate, for each respective row, row metadata that includes the row-level sparsity information.

4. The method of claim 3, wherein elements of the weight matrix comprise values in {−1, 0, +1}, such that the non-zero elements have magnitude one.

5. The method of claim 4, further comprising, for each row of the weight matrix, determining a sign for each non-zero element, and wherein the row metadata further includes sign information associated with non-zero positions in the row.

6. The method of claim 3, wherein the at least one client device is configured to:
partition, for each respective row, the row metadata into the public row metadata and private row metadata according to a security policy; and
transmit the public row metadata to the at least one server in unencrypted form while retaining the private row metadata locally.

7. The method of claim 6, wherein partitioning the row metadata into the public row metadata and the private row metadata comprises:
designating the row-level sparsity information as part of the public row metadata; and
designating at least a portion of sign information associated with non-zero positions in the respective row as part of the private row metadata.

8. The method of claim 7, wherein the security policy designates both the row-level sparsity information and the sign information as the public row metadata, and wherein deriving the encrypted row result comprises using the sign information and the encrypted partial sum to compute, using homomorphic operations defined by the encryption scheme, the encrypted row result without using the private row metadata.

9. The method of claim 1, wherein grouping the rows based on the public row metadata comprises:
computing a pattern key for each row from the public row metadata that encodes at least the pattern of the non-zero column indices; and
assigning rows having a same pattern key to a same pattern group.

10. The method of claim 1, wherein homomorphically summing for each pattern group comprises applying an addition operation defined by the encryption scheme to ciphertexts associated with encrypted input vector elements at the non-zero column indices indicated by the pattern descriptor for the respective pattern group, while omitting ciphertexts associated with zero elements of the weight matrix.

11. The method of claim 1, wherein the encryption scheme is a partially homomorphic encryption (PHE) scheme.

12. The method of claim 11, wherein the MLM is a 1-bit large language model (LLM), and the weight matrix represents weights of a 1-bit linear layer of the 1-bit LLM.

13. The method of claim 1, further comprising:
performing, at the at least one server, the grouping of rows and the generating of the pattern descriptors as an offline preprocessing operation using the public row metadata; and
reusing the pattern descriptors to compute the encrypted partial sums for a plurality of different encrypted input vectors associated with a plurality of invocations of the MLM.

14. The method of claim 1, wherein the at least one client device is configured to:
encrypt a plurality of elements of an input vector associated with the linear operation using the encryption scheme to obtain the encrypted input vector; and
transmit the encrypted input vector to the at least one server.

15. The method of claim 1, wherein the public row metadata is used to route the encrypted elements of the encrypted input vector to a shared homomorphic partial-sum computation associated with a pattern group, and wherein the shared homomorphic partial-sum computation is reused for a plurality of rows mapped to the pattern group.

16. The method of claim 1, wherein the public row metadata comprises the non-zero column indices for each row, and private row metadata retained at the at least one client device comprises at least one of: sign information for one or more non-zero entries, row-specific scaling information, or row-specific completion logic, such that the at least one server computes one or more encrypted partial sums using the public row metadata and the at least one client device completes a row output using the private row metadata after decryption.

17. The method of claim 1, further comprising storing, at the at least one server, pattern descriptors and row-to-pattern mappings generated from the public row metadata and reusing the stored pattern descriptors and the row-to-pattern mappings across a plurality of encrypted input vectors associated with a plurality of invocations of the machine learning model.

18. A system for securely computing at least a portion of a linear operation of a machine learning model (MLM), the system comprising:
at least one memory; and
at least one hardware processor coupled with the at least one memory and configured, individually or in combination, to:
receive, from at least one client device by at least one server, public row metadata comprising sets of non-zero column indices for rows of a weight matrix associated with the linear operation;
group, at the at least one server, the rows of the weight matrix into a plurality of pattern groups based on the public row metadata, wherein each pattern group of the plurality of pattern groups comprises two or more rows that share a same pattern of non-zero column indices;
generate, for each respective pattern group of the plurality of pattern groups, a pattern descriptor that identifies a pattern of non-zero column indices shared by rows in the respective pattern group;
receive an encrypted input vector from the at least one client device;
for each respective pattern group of the plurality of pattern groups:
homomorphically sum, using an encryption scheme, encrypted elements of the encrypted input vector selected according to a corresponding pattern descriptor to obtain at least one encrypted partial sum corresponding to the respective pattern group; and
derive, for each row in the respective pattern group, an encrypted row result based on the at least one encrypted partial sum corresponding to the respective pattern group; and
transmit, from the at least one server to the at least one client device, encrypted row results, encrypted partial sums, and mapping information associating rows to pattern groups.

19. The system of claim 18, wherein the at least one client device is configured to:
receive, from the at least one server, the encrypted row results, the encrypted partial sums, and the mapping information associating rows to pattern groups;
decrypt at least one of the encrypted row results or the encrypted partial sums; and
generate, using private row metadata, a plaintext output element of the linear operation for a corresponding row.

20. The system of claim 18, wherein the at least one client device is configured to:
determine, for each respective row of the weight matrix, a set of column indices corresponding to non-zero elements to obtain row-level sparsity information; and
generate, for each respective row, row metadata that includes the row-level sparsity information.

21. A non-transitory computer readable medium storing thereon computer executable instructions for securely computing at least a portion of a linear operation of a machine learning model (MLM), including instructions for:
receiving, from at least one client device by at least one server, public row metadata comprising sets of non-zero column indices for rows of a weight matrix associated with the linear operation;
grouping, at the at least one server, the rows of the weight matrix into a plurality of pattern groups based on the public row metadata, wherein each pattern group of the plurality of pattern groups comprises two or more rows that share a same pattern of non-zero column indices;
generating, for each respective pattern group of the plurality of pattern groups, a pattern descriptor that identifies a pattern of non-zero column indices shared by rows in the respective pattern group;
receiving an encrypted input vector from the at least one client device;
for each respective pattern group of the plurality of pattern groups:
homomorphically summing, using an encryption scheme, encrypted elements of the encrypted input vector selected according to a corresponding pattern descriptor to obtain at least one encrypted partial sum corresponding to the respective pattern group; and
deriving, for each row in the respective pattern group, an encrypted row result based on the at least one encrypted partial sum corresponding to the respective pattern group; and
transmitting, from the at least one server to the at least one client device, encrypted row results, encrypted partial sums, and mapping information associating rows to pattern groups.
